(19) United States
(12) Patent Application Publication
(10) Pub. No.: US 2002/0123908 A1
(43) Pub. Date: Sep. 5, 2002

(54) Health care system

(76) Inventors: Yasushi Ando, Saijo-shi (JP); Chie Nishikawa, Uji-shi (JP); Hiroshi Dohi, Osaka (JP)

Correspondence Address: WALL MARJAMA & BILINSKI, 101 SOUTH SALINA STREET, SUITE 400, SYRACUSE, NY, 13202, US

(21) Appl. No.: 10/078,307

(22) Filed: Feb. 19, 2002

(30) Foreign Application Priority Data
Feb. 16, 2001 (JP) 2001-40713

(51) Int. Cl. G06F 17/60

(52) U.S. Cl. 705/2

(57) ABSTRACT

A health care system comprises plural subscriber terminal devices, a data management center, and a communication line connecting the subscriber terminal devices to the data management center, wherein each subscriber terminal device comprises an input means for inputting health data of the corresponding subscriber, a storage means for holding the inputted health data, a first communication means for performing data communication with the data management center, a display means for displaying the health data and information from the data management center, and an operation means with which the subscriber performs a series of operations; and the data management center comprises a second communication means for performing data communication with each subscriber terminal device, a storage means for holding health data transmitted from each subscriber terminal device, a group decision means for deciding a group to which each subscriber belongs on the basis of plural pieces of health data obtained from the storage means, and an advising means for providing each subscriber terminal device with plural advice candidates which are common to subscribers in the group to which the subscriber terminal device belongs, through the second communication means. Therefore, the health care system can encourage each subscriber to continuously measure health data and send the health data to the external data management center.

### FIELD OF THE INVENTION

The present invention relates to a health care system for preventing life style-related diseases, which comprises terminal devices installed at homes or the like, an external data management center, and a communication circuit for connecting each terminal device with the external data management center. More particularly, the invention relates to a health care system which is improved so as to perform promotion and support for transmission of heath data from a subscriber as well as management of the health data at the external data management center.

### BACKGROUND OF THE INVENTION

In order to prevent life style-related diseases, self-awareness of each person and improvement of his/her life style are necessary. Once a person takes a life style-related disease, he/she has to go to hospital regularly over a long period of time. Therefore, an at-home health care system for preventing the onset of a disease and monitoring the condition of a patient has conventionally been proposed.

For example, Japanese Published Patent Application No. Hei. 2-279056 discloses a data collection system for transmitting a blood sugar level of a diabetic patient who has drawn blood by him/herself, to a hospital through a telephone line, and managing the data at the hospital. Meanwhile, Japanese Published Patent Application No. Hei. 3-268739 discloses a data transmission system for transmitting a body surface potential signal of a patient who is outside a hospital, to an electrocardiogram analyzing system installed at the hospital through a telephone line, thereby examining the function of the circulatory system of the patient.

Furthermore, Japanese Published Patent Application No. Hei. 10-500598 proposes a system for monitoring and reporting physiological characteristic data which is measured by a patient, and an embodiment of this prior art discloses a system for establishing a bi-directional communication link between an asthmatic patient and a doctor, without intervention of another person, during a process of executing a care plan which is formed by the doctor for the asthmatic patient, that is, a system for achieving, by an economical method, collection, processing, and transmission of respiration data obtained by an individual.

As described above, the conventional at-home health care system is constituted by subscriber terminal devices and an external data management center. The external data management center manages health data of each subscriber, and feeds the progression of the managed health data back to the subscriber, thereby to encourage self-awareness of the subscriber, which leads to improvement of the life style of the subscriber.

In the conventional health care system, it is necessary to increase the system operating efficiency by providing many subscribers with advices on improvement of their life styles collectively. However, since the life styles vary among the subscribers, this method cannot provide each subscriber with an advice suited to his/her life style.

Furthermore, although the conventional health care system aims to improve the life style of each subscriber by providing the subscriber with an appropriate advice for improvement of the life style, continuation of the will to improve the life style depends on the subscriber. The frequency of transmission of health data to the external data management center is often reduced due to negligence of each subscriber and, worse yet, the transmission might be abandoned, resulting in insufficient function of the health care system.

### SUMMARY OF THE INVENTION

The present invention is made to solve the above-mentioned problems and has for its object to provide a health care system by which an external data management center can provide many subscribers with appropriate advices at low cost, and the subscribers are encouraged to continuously measure their health data and transmit the health data to the external data management center.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a 1st aspect of the present invention, there is provided a health care system for exchanging data of predetermined subscribers between plural subscriber terminal devices and a data management center through a communication line, wherein each of the subscriber terminal devices comprises: an input means for inputting health data of the corresponding subscriber; a storage means for holding the health data inputted by the input means; a first communication means for performing data communication with the data management center; a display means for displaying the health data inputted by the input means, and information transmitted from the data management center; and an operation means with which the subscriber performs a series of operations; and the data management center comprises: a second communication means for performing data communication with each of the respective subscriber terminal devices; a storage means for holding health data transmitted from each of the subscriber terminal devices; a group decision means for deciding a group to which each subscriber belongs, on the basis of plural pieces of health data obtained from the storage means; and an advising means for providing each subscriber terminal device with plural advice candidates which are common to subscribers in the group to which the subscriber terminal device belongs, through the second communication means. Therefore, the subscribers can be classified into plural groups, each group including subscribers having risks of approximately equal levels, by performing grouping on the basis of plural kinds of health data which are physiologically different from each other, such as blood sugar levels and weights of the subscribers, and the subscribers are provided with plural advices which widely cover the life styles that vary among individuals and are common to the subscribers in the same group, whereby appropriate advices can be efficiently given to many subscribers. According to a 2nd aspect of the present invention, in the health care system according to the 1st aspect, the subscriber terminal device further includes an advice selection means for selecting at least one advice candidate which is desired by the corresponding subscriber, from the plural advice candidates supplied from the advising means. Therefore, each subscriber can select advices suited to his/her life style.

According to a 3rd aspect of the present invention, in the health care system according to the 2nd aspect, the data management center further includes an advice registration means for holding the advice candidate selected by the advice selection means; and the data management center provides the subscriber terminal device with the advice candidate stored in the advice registration means, as an advice, by the advising means. Therefore, each subscriber can confirm the advices selected by him/herself to make efforts for improving his/her life style.

According to a 4th aspect of the present invention, in the health care system according to the 1 st aspect, the group decision means remakes the group to which the subscriber belongs, according to a change in the health data transmitted from the subscriber terminal device; and the advising means provides the subscriber terminal device with plural advice candidates which are common to the subscribers who belong to the remade group. Therefore, each subscriber can be provided with appropriate advices according to a change in his/her health data.

According to a 5th aspect of the present invention, in the health care system according to the 1 st aspect, the health data includes data relating to blood sugar level, and weight or body mass index (BMI). Therefore, health data corresponding to the life style-related diseases of the respective subscribers can be adopted.

According to a 6th aspect of the present invention, in the health care system according to the 1 st aspect, the health data includes data relating to blood pressure, and weight or body mass index (BMI). Therefore, health data corresponding to the life style-related diseases of the respective subscribers can be adopted.

According to a 7th aspect of the present invention, in the health care system according to the 1st aspect, the health data includes data relating to cholesterol, and weight or body mass index (BMI). Therefore, health data corresponding to the life style-related diseases of the respective subscribers can be adopted.

According to an 8th aspect of the present invention, in the health care system according to the 1st aspect, the health data includes data relating to neutral fat, and weight or body mass index (BMI). Therefore, health data corresponding to the life style-related diseases of the respective subscribers can be adopted.

According to a 9th aspect of the present invention, in the health care system according to the 1st aspect, the health data includes data relating to glutamic acid oxaloacetic acid transaminase (GOT), and weight or body mass index (BMI). Therefore, health data corresponding to the life style-related diseases of the respective subscribers can be adopted.

According to a 110th aspect of the present invention, in the health care system according to the 1st aspect, the health data includes data relating to glutamic acid pyrivic acid transaminase (GPT), and weight or body mass index (BMI). Therefore, health data corresponding to the life style-related diseases of the respective subscribers can be adopted.

According to an 11th aspect of the present invention, in the health care system according to the 1st aspect, the health data includes data relating to γ-glutamyl transpeptidase, and weight or body mass index (BMI). Therefore, health data corresponding to the life style-related diseases of the respective subscribers can be adopted.

According to a 12th aspect of the present invention, there is provided a health care system for exchanging data of predetermined subscribers between plural subscriber terminal devices and a data management center through a communication line, wherein each of the subscriber terminal devices comprises: an input means for inputting health data; a storage means for holding the health data inputted by the input means; a first communication means for performing data communication with the data management center; a display means for displaying the health data and information from the data management center; and an operation means with which the subscriber performs a series of operations; and the data management center comprises: a second communication means for performing data communication with the subscriber terminal devices; and an ordinal rank decision means for deciding the ordinal ranks of the health data among the plural subscribers, on the basis of the health data which are obtained from the storage means for holding the health data transmitted from the subscriber terminal devices. Therefore, each subscriber can improve his/her life style while comparing a change in his/her health data with those of other subscribers, thereby encouraging the subscriber to keep the will to improve the life style.

According to a 13th aspect of the present invention, in the health care system according to the 12th aspect, the ordinal rank decision means includes a health data improvement degree calculation means for calculating the degree of improvement in the health data of each subscriber by comparing the health data with a standard value or an index value; and the ordinal rank according to the degree of improvement is employed as the ordinal rank of the health data. Therefore, each subscriber can improve his/her life style while comparing a change in his/her health data with those of other subscribers, according to the degree of improvement relative to a standard value or an index value, thereby encouraging the subscriber to keep the will to improve the life style.

According to a 14th aspect of the present invention, in the health care system according to the 12th aspect, the subscriber terminal device further includes an improvement target setting means for setting an improvement target value of the health data. Therefore, each subscriber can improve his/her life style by setting a target value in improvement of health data, thereby encouraging the subscriber to keep the will to improve the life style.

According to a 15th aspect of the present invention, in the health care system according to the 12th aspect, the data management center further includes an improvement target value registration means for holding the improvement target value which is set by the improvement target setting means of the 14th aspect, through the second communication means; the ordinal rank decision means includes a target value achievement degree calculation means for calculating the degree of achievement to the improvement target value of the subscriber, which is stored in the improvement target value registration means; and the ordinal rank according to the degree of achievement is employed as the ordinal rank of the health data. Therefore, each subscriber can improve his/her life style while comparing a change in his/her health data with those of other subscribers, according to the degree of achievement to an improvement target value that is set by the subscriber, thereby encouraging the subscriber to keep the will to improve the life style.

According to a 16th aspect of the present invention, there is provided a health care system for exchanging data of predetermined subscribers between plural subscriber terminal devices and a data management center through a communication line, wherein each of the subscriber terminal devices comprises: an input means for inputting health data and information; a storage means for holding the health data and information which are inputted by the input means; a first communication means for performing data communication with the data management center; a display means for displaying the health data and information from the data management center; and an operation means with which the subscriber performs a series of operations; and the data management center comprises: a second communication means for performing data communication with the subscriber terminal devices; a storage means for holding the health data transmitted from the subscriber terminal devices; and an electronic bulletin board means in/from which topics or the like relating to health can be written or read by the subscriber terminal devices through the second communication line. Therefore, each subscriber can improve his/her life style while exchanging information with other subscribers via the electronic bulletin board, thereby encouraging the subscriber to keep the will to improve the life style.

According to a 17th aspect of the present invention, there is provided a health care system for exchanging data of predetermined subscribers between plural subscriber terminal devices and a data management center through a communication line, wherein each of the subscriber terminal devices comprises: an input means for inputting health data and information; a storage means for holding the health data and information which are inputted by the input means; a first communication means for performing data communication with the data management center; a display means for displaying the health data and information from the data management center; and an operation means with which the subscriber performs a series of operations; and the data management center comprises: a second communication means for performing data communication with the subscriber terminal devices; a storage means for holding the health data transmitted from the subscriber terminal devices; a profile registration means for holding profile data of each subscriber, such as sex, hobby and the like; and a group decision means for deciding a group to which each subscriber belongs, on the basis of the stored profile data of the subscriber. Therefore, the health data of each subscriber is managed within the group of subscribers whose profiles are similar to the profile of the subscriber, which makes the subscriber feel comfortable, thereby encouraging the subscriber to keep the will to improve the life style.

According to an 18th aspect of the present invention, in the health care system according to the 17th aspect, the data management center further includes an ordinal rank decision means for deciding the ordinal ranks of the health data among the subscribers in the group to which the subscribers belong, which group is created by the group decision means on the basis of the health data obtained from the storage means. Therefore, each subscriber can improve his/her life style while comparing a change in his/her health data with those of other subscribers in the group of subscribers whose profiles are similar to the profile of the subscriber, thereby encouraging the subscriber to keep the will to improve the life style.

According to a 19th aspect of the present invention, in the health care system according to the 18th aspect, the ordinal rank decision means includes a health data improvement degree calculation means for calculating the degree of improvement in the health data of each subscriber by comparing the health data with a standard value or an index value; and the ordinal rank based on the degree of improvement is employed as the ordinal rank of the health data. Therefore, each subscriber can improve his/her life style while comparing a change in his/her health data relative to a standard value or index value, with those of other subscribers, in the group of subscribers whose profiles are similar to the profile of the subscriber, thereby encouraging the subscriber to keep the will to improve the life style.

According to a 20th aspect of the present invention, in the health care system according to the 17th aspect, the subscriber terminal device includes an improvement target setting means for setting an improvement target value of the health data. Therefore, each subscriber can improve his/her life style by setting a target value in improvement of health data, in the group of subscribers whose profiles are similar to the profile of the subscriber, thereby encouraging the subscriber to keep the will to improve the life style.

According to a 21st aspect of the present invention, in the health care system according to the 17th aspect, the data management center includes an improvement target value registration means for holding the improvement target value which is set by the improvement target setting means of the 20th aspect, through the second communication means; the health data ordinal rank decision means of the 18th aspect includes a target value achievement degree calculation means for calculating the degree of achievement to the improvement target value of each subscriber, which target value is stored in the improvement target value registration means that decides the ordinal ranks of the health data among the subscribers in the group to which the subscribers belong; and the ordinal rank according to the degree of achievement is employed as the ordinal rank of the health data of each subscriber. Therefore, each subscriber can improve his/her life style while comparing a change in his/her health data with those of other subscribers, according to the degree of achievement to an improvement target value that is set by the subscriber, in the group of subscribers whose profiles are similar to the profile of the subscriber, thereby encouraging the subscriber to keep the will to improve the life style.

According to a 22nd aspect of the present invention, in the health care system according to the 17th aspect, the data management center includes an electronic bulletin board means in/from which topics or the like relating to health can be written or read by the subscriber terminal devices through the second communication means, only in the group to which the subscribers belong, which group is created by the group decision means. Therefore, each subscriber can improve his/her life style while exchanging information with other subscribers in the group of subscribers whose profiles are similar to the profile of the subscriber, thereby encouraging the subscriber to keep the will to improve the life style.

According to a 23rd aspect of the present invention, the health care system according to the 12th or 17th aspect further includes a point management means for converting at least one of the degree of improvement described for the 13th aspect, the degree of achievement described for the 15th aspect, and the number of transmission of the health data which are obtained from the storage means for holding the health data transmitted from the subscriber terminal device, into service points (hereinafter, referred to simply as points); accumulating and managing the points, and sending the accumulated points and bonus information such as gifts to the subscriber terminal device through the second communication means, when there is a request to use the points from the subscriber terminal device through the second communication means; and when there is a request for a bonus such as a gift from the subscriber terminal device, exchanging the points corresponding to the bonus, for the bonus. Therefore, each subscriber can improve his/her life style by transmitting his/her health data to the external data management center, getting points when the health data is improved, and exchanging the points for a bonus such as a gift, thereby encouraging the subscriber to keep the will to improve the life style.

According to a 24th aspect of the present invention, in the health care system according to any of the 12th, 16th, 17th, and 23rd aspects, the health data includes data relating to blood sugar level, weight, and number of steps. Therefore, health data corresponding to the life style-related diseases of the respective subscribers can be adopted.

According to a 25th aspect of the present invention, in the health care system according to any of the 12th, 16th, 17th, and 23rd aspects, the health data includes data relating to blood pressure, weight, and number of steps. Therefore, health data corresponding to the life style-related diseases of the respective subscribers can be adopted.

According to a 26th aspect of the present invention, in the health care system according to any of the 12th, 16th, 17th, and 23rd aspects, the health data includes data relating to cholesterol, weight, and number of steps. Therefore, health data corresponding to the life style-related diseases of the respective subscribers can be adopted.

According to a 27th aspect of the present invention, in the health care system according to the 1st aspect, the subscriber terminal device further includes a first control means for controlling the respective means constituting the subscriber terminal device; the data management enter further includes a second control means for controlling the respective means constituting the data management center; the first control means controls the first communication means so as to transmit the health data of the subscriber, which is inputted from the input means; the second control means controls the second communication means so as to receive the health data; the second control means controls the group decision means so as to decide a group to which the subscriber belongs, on the basis of the health data; and the second control means controls the advising means so as to create advice candidates suited to the group. Therefore, the subscribers can be classified into plural groups, each group including subscribers having risks of approximately equal levels, by performing grouping on the basis of plural kinds of health data which are physiologically different from each other, such as blood sugar levels and weights of the subscribers, and the system is controlled such that the subscribers are provided with plural advices which widely cover the life styles that vary among individuals and are common to the subscribers in the same group, whereby appropriate advices can be efficiently given to many subscribers.

According to a 28th aspect of the present invention, in the health care system according to the 27th aspect, the first control means controls the first communication means so as to receive the advice candidates; the first control means controls the display means of the 1st aspect so as to display the advice candidates; and the first control means controls the first communication means so as to transmit an advice candidate selected by the input means of the 1st aspect. Therefore, the health care system can be controlled such that each subscriber can select advices suited to his/her life style.

According to a 29th aspect of the present invention, in the health care system according to the 27th aspect, the second control means controls the second communication means so as to receive the selected advice candidate described for the 28th aspect; the second control means controls the storage means of the 1st aspect so as to hold at least one advice candidate received; and the second control means controls the second communication means so as to transmit the stored advice. Therefore, the health care system can be controlled such that each subscriber can confirm the advices selected by him/herself, thereby encouraging the subscriber to make efforts for improving the life style.

According to a 30th aspect of the present invention, in the health care system according to the 27th aspect, the second control means controls the group decision means so as to remake the group according to a change in the health data transmitted through the first communication means; and the second control means controls the second communication means so as to transmit plural advice candidates which are common to the remade group. Therefore, the health care system can be controlled so as to provide each subscriber with appropriate advices according to a change in the health data of the subscriber.

According to a 31st aspect of the present invention, in the health care system according to the 12th aspect, the subscriber terminal device further includes a first control means for controlling the respective means constituting the subscriber terminal device; the data management center further includes a second control means for controlling the respective means constituting the data management center; the first control means controls the first communication means so as to transmit the health data; the second control means controls the second communication means so as to receive the health data; and the second control means controls the ordinal rank decision means so as to decide the ordinal ranks among the subscribers on the basis of the health data. Therefore, the health care system can be controlled so as to decide the ordinal ranks which are data for making each subscriber try to improve the life style while comparing a change in his/her health data with those of other subscribers, thereby encouraging the subscriber to keep the will to improve the life style.

According to a 32nd aspect of the present invention, in the health care system according to the 31st aspect, the second control means controls the ordinal rank decision means so as to calculate the degree of improvement in the health data of each subscriber by comparing the health data with a standard value or an index value, as the ordinal rank of the heath data. Therefore, the health care system can be controlled so as to calculate the degree of improvement relative to a standard value or index value, and the subscriber can improve the life style while comparing a change in his/her health data with those of other subscribers, thereby encouraging the subscriber to keep the will to improve the life style.

According to a 33rd aspect of the present invention, in the health care system according to the 31st aspect, the first control means controls the first communication means so as to transmit the improvement target value of the health data which is inputted by the input means of the 12th aspect, thereby setting the improvement target value. Therefore, the health care system can be controlled such that each subscriber can improve the life style by setting a target value in improvement of his/her health data, thereby encouraging the subscriber to keep the will to improve the life style.

According to a 34th aspect of the present invention, in the health care system according to the 31st aspect, the second control means controls the second communication means so as to receive the improvement target value described for the 33rd aspect, and controls the storage means of the 12th aspect so as to hold the improvement target value; the second control means controls the ordinal rank decision means so as to calculate the degree of achievement on the basis of the health data received from the second communication means and the stored improvement target value; and the second control means controls the ordinal rank decision means so as to decide the ordinal rank of the health data according to the rank based on the degree of achievement. Therefore, the health care system can be controlled so as to calculate the degree of achievement to an improvement target value that is set by each subscriber, and the subscriber can improve the life style while comparing a change in his/her health data with those of other subscribers, thereby encouraging the subscriber to keep the will to improve the life style.

According to a 35th aspect of the present invention, in the health care system according to the 16th aspect, the subscriber terminal device further includes a first control means for controlling the respective means constituting the subscriber terminal device; the data management center further includes a second control means for controlling the respective means constituting the data management center; the first control means controls the first communication means so as to transmit topics relating to health or the like; the second control means controls the second communication means so as to receive the topics relating to health or the like; and the second control means control the electronic bulletin board means so as to display the received topics. Therefore, the health care system can be controlled so as to display information on the electronic bulletin board which is a place for interaction among the subscribers, and each subscriber can improve the life style while exchanging information with other subscribers via the electronic bulletin board, thereby encouraging the subscriber to keep the will to improve the life style.

According to a 36th aspect of the present invention, in the health care system according to the 17th aspect, the subscriber terminal device further includes a first control means for controlling the respective means constituting the subscriber terminal device; the data management center further includes a second control means for controlling the respective means constituting the data management center; the first control means controls the first communication means so as to transmit profile data of the subscriber; the second control means controls the second communication means so as to receive the profile data, and controls the storage means so as to hold the profile data; and the second control means controls the group decision means so as to decide the group to which the subscriber belongs, on the basis of the profile data stored in the storage means. Therefore, the health care system can be controlled so as to manage the health data of each subscriber in the group of subscribers whose profiles are similar to that of the subscriber, which makes the subscriber feel comfortable, thereby encouraging the subscriber to keep the will to improve the life style.

According to a 37th aspect of the present invention, in the health care system according to the 36th aspect, the second control means controls the ordinal rank decision means of the 31st aspect so as to decide the ordinal rank of the health data within the group to which the subscriber belongs, which group is decided by the group decision means. Therefore, the health care system can be controlled such that each subscriber can compare a change in his/her health data with those of other subscribers in the group of subscribers whose profiles are similar to that of the subscriber, whereby the subscriber can improve the life style while comparing a change in his/her health data with those of other subscribers, thereby encouraging the subscriber to keep the will to improve the life style.

According to a 38th aspect of the present invention, in the health care system according to the 37th aspect, the second control means controls the second communication means of the 36th aspect so as to receive the health data of the subscriber; and the second control means controls the ordinal rank decision means of the 17th aspect so as to calculate the degree of achievement by comparing the received health data with a standard value or an index value. Therefore, the health care system can be controlled such that each subscriber can compare a change in his/her health data relative to a standard value or index value, with those of other subscribers, in the group of subscribers whose profiles are similar to that of the subscriber, whereby the subscriber can improve his/her life style while comparing a change in his/her health data with those of other subscribers, thereby encouraging the subscriber to keep the will to improve the life style.

According to a 39th aspect of the present invention, in the health care system according to the 36th aspect, the first control means controls the first communication means so as to transmit the improvement target value of the health data which is inputted by the input means of the 17th aspect. Therefore, the health care system can be controlled such that each subscriber can set a target value in improvement of his/her health data in the group of subscribers whose profiles are similar to that of the subscriber, whereby the subscriber can improve the life style by setting a target value in improvement of the health data, thereby encouraging the subscriber to keep the will to improve the life style.

According to a 40th aspect of the present invention, in the health care system according to the 36th aspect, the second control means controls the second communication means so as to receive the improvement target value described in the 33rd aspect; the second control means controls the storage means so as to hold the received improvement target value; and the second control means control the ordinal rank decision means of the 31st aspect so as to calculate the degree of achievement to the improvement target value of the subscriber. Therefore, the health care system can be controlled such that each subscriber can compare a change in his/her health data with those of other subscribers, according the degree of achievement to an improvement target value that is set by the subscriber, in the group of subscribers whose profiles are similar to that of the subscriber, whereby the subscriber can improve the life style while comparing a change in his/her health data with those of other subscribers, thereby encouraging the subscriber to keep the will to improve the life style.

According to a 41st aspect of the present invention, in the health care system according to the 36th aspect, the second control means controls the electronic bulletin board means of the 22nd aspect so as to permit only the subscribers decided by the group decision means to read or write data from/in the bulletin board means. Therefore, the health care system can be controlled such that each subscriber can exchange information with other subscribers via the electronic bulletin board in the group of subscribers whose profiles are similar to that of the subscriber, thereby encouraging the subscriber to keep the will to improve the life style.

According to a 42nd aspect of the present invention, in the health care system according to the 31st or 36th aspect, the second control means controls the point management means of the 23rd aspect so as to convert at least one of the degree of improvement calculated by the health data improvement degree calculation means of the 13th aspect, the degree of target achievement calculated by the target achievement degree calculation means of the 15th aspect, and the number of transmission of the health data obtained from the storage means, into service points (hereinafter referred to simply as points); the first control means controls the first communication means so as to transmit a request to use the points, which request is inputted from the input means of the 17th aspect; the second control means controls the second communication means so as to transmit information about bonuses which can be obtained using the points; the first control means controls the first communication means so as to receive the bonus information; the first control means controls the first communication means so as to transmit the bonus information selected by the input means; and the second control means controls the point management means so as to exchange the points for the bonus corresponding to the selected bonus information. Therefore, the health care system can be controlled so that each subscriber can transmit his/her health data to the external data management center, earn points by improving the health data, and exchange the points for a bonus such as a gift, whereby the subscriber can improve the life style while exchanging the points with a bonus such as a gift, thereby encouraging the subscriber to keep the will to improve the life style.

### BRIEF DESCRIPTION OF THE DRAWINGS

For a further understanding of these and other objects of the invention, reference will be made to the following detailed description of the invention which is to be read in connection with the accompanying drawing, wherein:

FIG. 1 is a conceptual diagram illustrating a health care system according to a first embodiment of the present invention.

FIG. 2 is a block diagram illustrating the structure of a subscriber terminal device according to the first embodiment.

FIG. 3 is a functional block diagram illustrating an external data management center according to the first embodiment.

FIG. 4 is a flow chart for explaining the operation of the subscriber terminal device according to the first embodiment.

FIG. 5 is a block diagram for explaining group decision and advice provision according to the first embodiment.

FIG. 6 is a diagram illustrating an example of a group table according to the first embodiment.

FIG. 7 is a diagram illustrating an example of an advice table according to the first embodiment.

FIG. 8 is a conceptual diagram illustrating a health care system according to a second embodiment of the present invention.

FIG. 9 is a block diagram illustrating the structure of a subscriber terminal device according to the second embodiment.

FIG. 10 is a functional block diagram illustrating an external data management center according to the second embodiment.

FIG. 11 is a flowchart for explaining the operation of the subscriber terminal device according to the second embodiment.

FIG. 12 is a diagram illustrating health data to be transmitted, according to the second embodiment.

FIG. 13 is a diagram illustrating an example of subscriber data according to the second embodiment.

FIG. 14 is a block diagram for explaining group decision according to the second embodiment.

FIG. 15 is a block diagram for explaining improvement degree/achievement degree calculation and ordinal rank decision according to the second embodiment.

FIG. 16 is a diagram illustrating an example of a report to be transmitted to the subscriber terminal device, according to the second embodiment.

FIG. 17 is a block diagram illustrating an electronic bulletin board according to the second embodiment.

FIG. 18 is a block diagram for explaining point management according to the second embodiment.

FIG. 19 is a diagram illustrating an example of a point conversion table according to the second embodiment.

FIG. 20 is a diagram illustrating an example of point data to be transmitted to the subscriber terminal device, according to the second embodiment.

FIG. 21 is a conceptual diagram illustrating a health care system according to a modification of the second embodiment.

FIG. 22 is a block diagram illustrating an advising means according to the modification of the second embodiment.

FIG. 23 is a block diagram illustrating an electronic Bulletin board according to the modification of the second embodiment.

FIG. 24 is a block diagram illustrating a point management means according to the modification of the second embodiment.

### DETAILED DESCRIPTION OF THE PREFERRED EMBODIMENTS

[Embodiment 1]

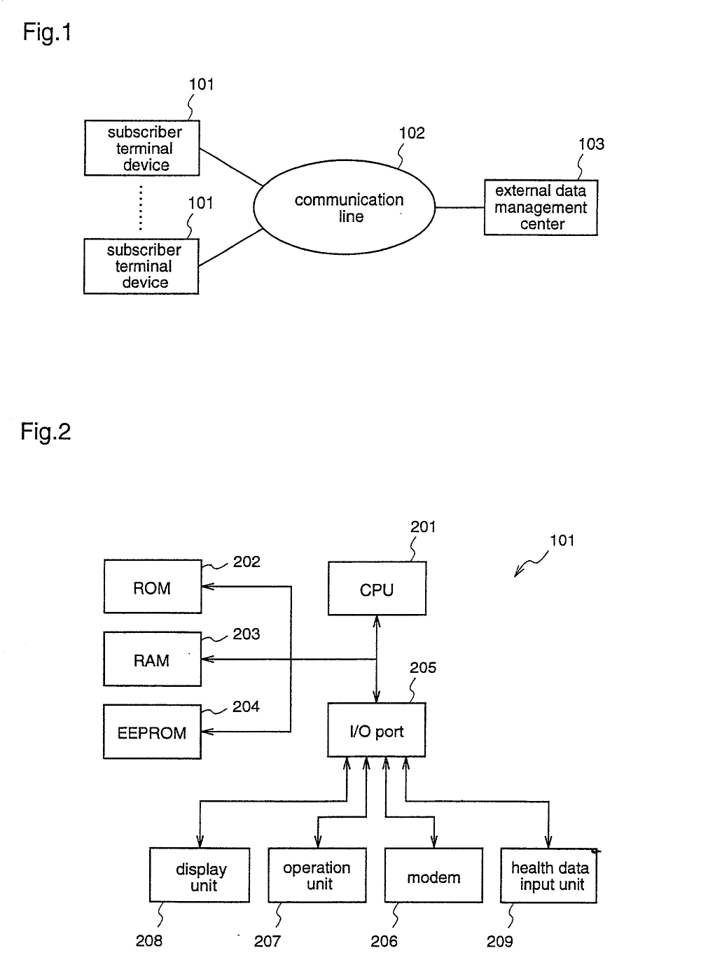

Hereinafter, a first embodiment of the present invention, which is defined in claims 1 11 and 27 30, will be described with reference to FIGS. 1 7.

In this first embodiment, subscribers are grouped on the basis of the similarities of their health data, plural advice candidates are transmitted to each group, and each subscriber selects at least one advise candidate that is suited to his/her life style. In this way, each subscriber is provided with an appropriate advice at reduced cost.

In this first embodiment, it is premised that fasting blood sugar level and weight are employed as health data. Instead of blood sugar level, data relating to any of blood pressure value, cholesterol value, neutral fat value, glutamic acid oxaloacetic acid transaminase (GOT) value, glutamic acid pyrivic acid transaminase (GPT) value, and γ-glutamyl transpeptidase (γ-GTP) value, may be employed. Further, body mass index (BMI) may be employed instead of weight.

FIG. 1 is a conceptual diagram illustrating a health care system according to the first embodiment.

The health care system is provided with an external data management center 103 as a server, and plural subscriber terminal devices 101 which are connectable to the external data management center 103 through a communication line 102.

While in this first embodiment a telephone line is employed as the communication line 102, it is also possible to employ a cable TV, a network such as the Internet, or a radio communication line. Depending on the subscriber, some of these lines may be employed together.

The external data management center 103 may be installed in a data management center of a private company or the like which is independent of a medical institution, or it may be installed in a medical institution.

Each subscriber terminal device 101 may be fixed at a home, or it may be carried by the subscriber. The subscriber terminal device 101 may be integrated with a fixed telephone or a handy phone.

FIG. 2 is a block diagram illustrating an example of the subscriber terminal device 101.

The subscriber terminal device 101 is provided with, in its minimum scale, a CPU 201, a ROM 202, a RAM 203, an EEPROM 204, an I/O port 205, a modem 206, an operation unit 207, and a display unit 208.

The CPU 201 (first control means) controls the whole of the subscriber terminal device 101.

The ROM 202 holds various kinds of programs or the like.

The RAM 203 (storage means) temporarily holds various kinds of data or the like, which are processed by the CPU 201.

The I/O port 205 (input means) performs input/output of data and control signals into/from the modem 206, the operation unit 207, the display unit 208, and the health data input part 209.

The operation unit 207 (input means, operation means, advice selection means) comprises a key board, a ten key pad, switches and the like, with which the subscriber performs various kinds of operations, and input of data or information.

The display unit 208 (display means) comprises an LCD, an LED, or the like, and displays a menu from which the subscriber selects items, health data, information from the external data management center 103, or the like, under control of the CPU 201.

Health data are directly inputted as numeric values from the ten key pad of the operation unit 207, and the inputted health data are stored in the RAM 203. However, there are cases where a health data measuring unit is connected to the health data input unit 209, and transmits data to receive health data, and where a health data measuring unit is contained in the body of the subscriber terminal device 101, and health data are obtained using the measuring unit. Furthermore, health data, which were submitted by mail or facsimile from the subscriber to the external data management center 103 when the subscriber subscribed to the health management service, may be transferred through the communication line 102 to the subscriber terminal device 101. In this case, the subscriber terminal device 101 can dispense with the health data input unit 209.

The modem 206 establishes a communication line with the external data management center 103 according to the operation of the operation unit 207, and performs transmission/reception of data to/from the center 103. The modem 206 may be an arbitrary device which conducts communication between the subscriber terminal device 101 and the external data management center 103 through the communication line 102. For example, a modem for ordinary telephone line, a cable modem for CATV, a modem for XDSL (ADSL, SDSL, or the like), a TA or dial-up rooter for ISDN may be employed.

The EEPROM 204 (storage means) holds information such as the inputted health data.

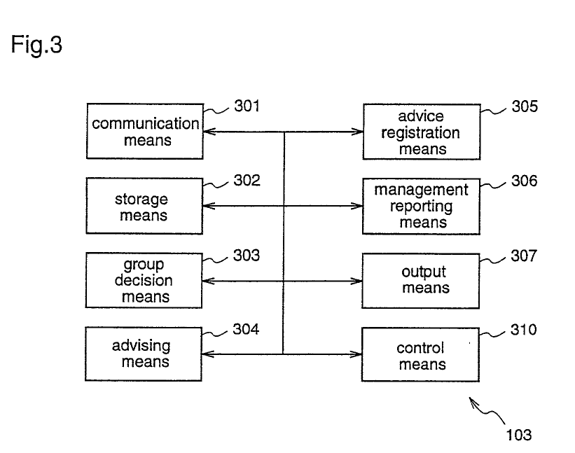

FIG. 3 is a block diagram illustrating various kinds of functions of the external data management center 103. These functions are substantially implemented by a server program possessed by the external data management center 103.

A communication means 301 (second communication means) conducts data communication with each subscriber terminal device 101 through the communication line 102, and conducts exchange of information between the respective functions of the external data management center 103 and the subscriber terminal device 101.

A storage means 302 receives the health data of the subscriber from the subscriber terminal device 101 through the communication means 301, and holds the health data.

A group decision means 303 automatically creates a group to which the subscriber belongs, on the basis of the health data stored in the storage means 302, and holds the group.

Further, the group decision means 303 detects a change in the health data stored in the storage means 302, and changes the group to which the subscriber belongs or creates a new group according to the change in the health data, and holds the changed or newly-created group.

An advising means 304 provides the subscriber terminal device 101 with advices about health care or advice candidates corresponding to the group to which the subscriber belongs, which group is held by the group decision means 303, through the communication means 301.

Furthermore, when the group decision means 303 changes the group to which the subscriber belongs or creates a new group and stores the group, the advising means 304 newly provides the subscriber terminal device 101 with plural advices corresponding to the group to which the subscriber belongs, through the communication means 301.

An advice registration means 305 receives the advice selected by the subscriber from the subscriber terminal device 101 through the communication means 301, and registers the advice to hold it.

Further, when the advising means 304 newly provides the subscriber terminal device 101 with plural advices corresponding to the group to which the subscriber belongs, the advice registration means 305 obtains an advice which is newly selected by the subscriber from the subscriber terminal device 101 through the communication means 301, and registers the advice to hold it.

A management reporting means 306 summarizes the health data stored in the storage means 302 or the advices stored in the advising means 304 into a form of a table or graph, and reports the health data or advices to the subscriber terminal device 101 through the communication means 301, in response to a request from the subscriber terminal device 101, or periodically. Alternatively, the management reporting means 306 outputs the health data or advices to an output means 307 which is connected to a printer, and prints the data or advices, and reports them to the subscriber or his/her family doctor by means of mail or facsimile.

A control means 310 (second control means) corresponds to a CPU of the server, and controls the above-mentioned means 301 to 307.

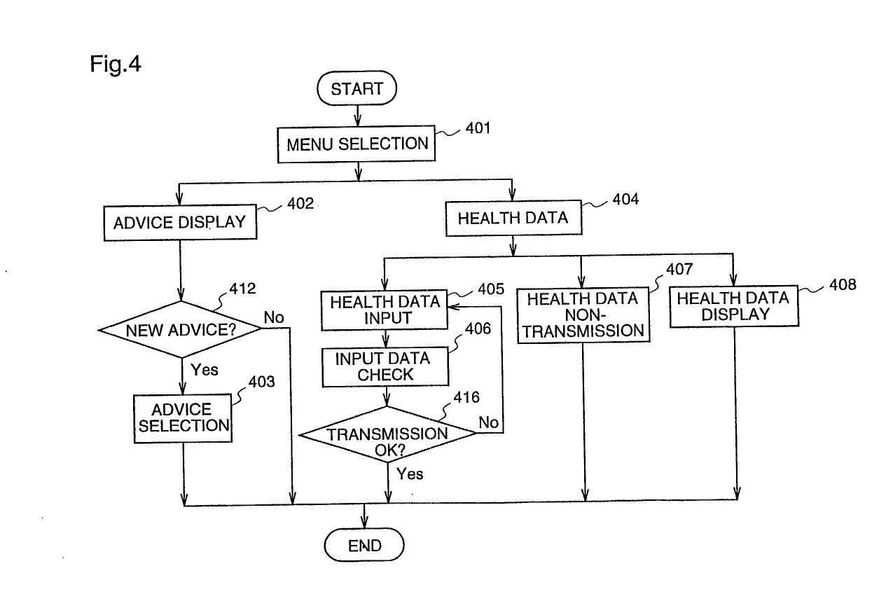

Next, an example of operation of the subscriber terminal device 101 will be described with reference to a flowchart shown in FIG. 4.

At the subscriber terminal device end, the subscriber selects either advice display menu 402 or health data menu 404 by menu selection 401.

When advice display menu 402 is selected, advices from the advising means 304 of the external data management center 103 are displayed, and when these advices are new (412), the subscriber goes to advice selection menu 403, and selects at least one advice that is suited to him/herself from plural advice candidates prepared. This selection is performed by that each subscriber presses an operation switch (not shown) on the operation unit 207 of the subscriber terminal unit 101, and the selected advice is registered and stored in the advice registration means 305 of the external data management center 103.

On the other hand, when health data menu 404 is selected, the subscriber selects one of the following menu items: health data input 405, health data non-transmission 407, and health data display 408.

When health data input menu 405 is selected, the subscriber enters health data (i.e., blood sugar level and weight) using the ten key pad (not shown) of the operation unit 207, and checks whether the inputted health data may be transmitted or not, on input data confirmation menu 406. When transmission is OK (416), the inputted data are transmitted to the external data management center 103, and stored in the storage means 302. When it is not OK on input data confirmation menu 406, the subscriber returns to health data input menu 405.

When the subscriber terminal device 101 is not connected to the communication line 102, for example, when it is carried by the subscriber, the health data are stored in the EEPROM 204, i.e., the health data are in the transmission-awaiting state.

When health data non-transmission menu 407 is selected, the non-transmitted health data stored in the EEPROM 204 can be transmitted to the external data management center 103 when the subscriber terminal device 101 is connected to the communication line 102 later.

When health data display menu 408 is selected, the health data and advices which are summarized in a graph or table and transmitted from the management reporting means 306 of the external data management center 103 can be displayed on the screen of the display unit 208.

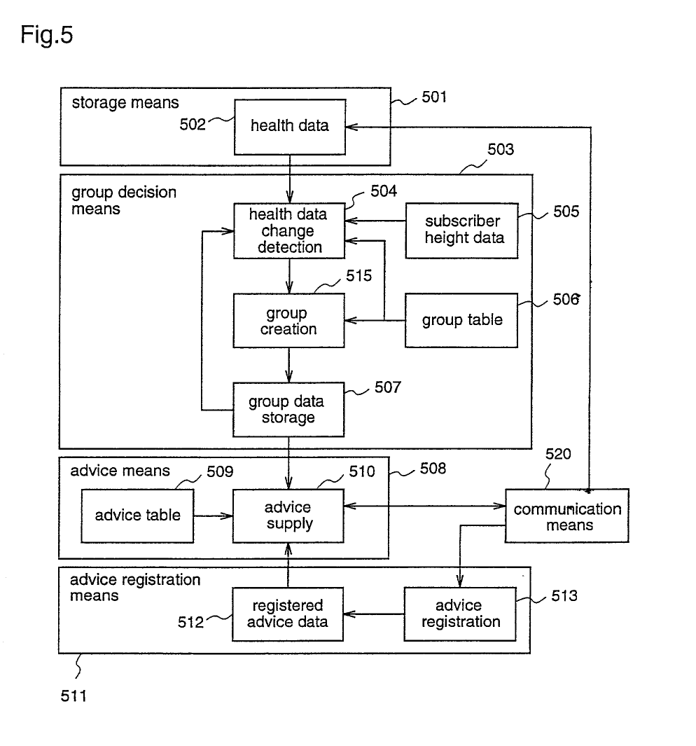

Next, a description will be given of processes for deciding the group to which a subscriber belongs, providing the subscriber with advices, making the subscriber select a suitable advice, and registering the selected advices, which processes are performed in the external data management center 103, with reference to a block diagram shown in FIG. 5.

Initially, health data 502, i.e., blood sugar level and weight, stored in a storage means 501 of the external data management center 103 are read by a group decision means 503, and transmitted to a health data change detector 504. In the health data change detector 504, weight is converted into a body mass index (BMI) which is calculated by an expression, (height m)²×22, from the height of the subscriber which has already been registered in a subscriber height data register 505, and an average blood sugar level and an average BMI over a predetermined period of time, for example, a month, are calculated, and thereafter, a change in the health data is checked according to whether or not the group corresponding to the calculated blood sugar level and BMI on a group table 506 is different from the group to which the subscriber belongs, which group is stored in a subscriber group data storage unit 507. When a change in the health data is detected, a group creation unit 515 decides a new group number to which the subscriber belongs and stores the number in the subscriber group data storage unit 507, and then notifies an advice provision unit 510 of an advising means 508 that the group to which the subscriber belongs is updated.

In the advising means 508, when the group to which the subscriber belongs is updated according to a request from the subscriber terminal device 101, the advice provision unit 510 provides the subscriber terminal device 101 with plural advice candidates on an advice table 509 which correspond to the subscriber group number stored in the subscriber group data storage unit 507, through the communication means 520. When the subscriber group number is not changed, an advice registered data unit 512 in which the advice candidates selected by the subscriber are stored, provides the subscriber terminal device 101 with the stored advice candidates, as practical advices.

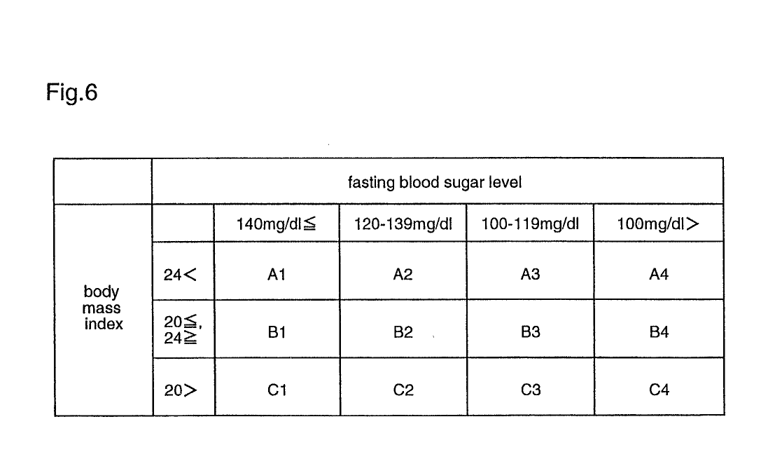

The advice candidates selected by the subscriber are transmitted from the subscriber terminal device 101 through a communication means 520 to an advice registration means 511, and an advice registration unit 513 stores the selected advice candidates in the advice registered data unit 512, FIG. 6 shows an example of a group table 506 of the group decision means 503. On the group table 506, the numbers of groups to which subscribers belong, A1 A4, B1 B4, C1 C4, are defined on the basis of the ranges into which the blood sugar levels and the body mass indexes (BMI) of the respective subscribers fall, more specifically, in the example of FIG. 6, the group numbers are defined by combinations of four ranges relating to blood sugar level and three ranges relating to weight.

The fasting blood sugar levels shown in FIG. 6 are based on the indexes of blood sugar levels which are described in “Diabetes Treatment Guide” (Japan Diabetes Society, 1999). According to this literature, the indexes of blood sugar levels under the blood sugar controlled state are as follows. As for fasting blood sugar levels, “under 100 mg/dl” is excellent, “100 119 mg/dl” is good, and “120 139 mg/dl” is satisfactory. As for blood sugar levels two hours after a meal, “under 120 mg/dl” is excellent, “120 169 mg/dl” is good, and “170 199 mg/dl” is satisfactory. Further, the body mass indexes (BMI) are based on the indexes defined by Japan Fatness Society, and it is advisable that the BMI should be within a range from 20 to 24.

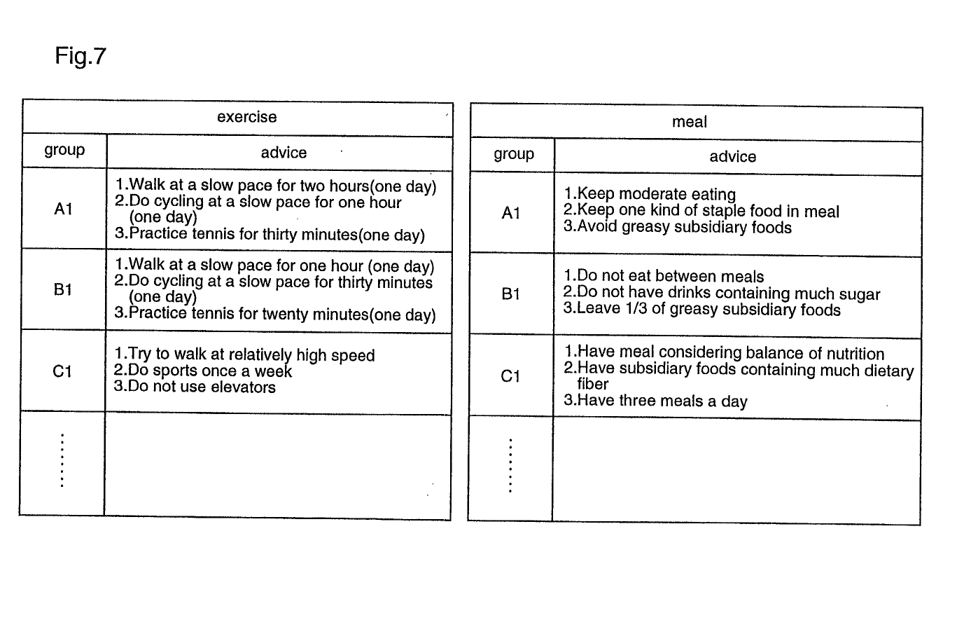

FIG. 7 shows examples of advices registered on the advice table 509 of the advising means 508. In FIG. 7, plural advice candidates are shown for each group, with respect to exercise and meal.

For example, for the group A1, three advice candidates with respect to exercise are prepared as follows: 1. Walk at a slow pace for two hours (one day), 2. Do cycling at a slow pace for one hour (one day), 3. Practice tennis for thirty minutes (one day).

Further, with respect to meal, three advice candidates are prepared as follows: 1. Keep moderate eating positively, 2. Keep one kind of stable food in meal, 3. Avoid subsidiary foods containing much oil.

Hereinafter, the operation of the whole health care system according to the first embodiment will be described. Each of subscribers transmits his/her health data from the subscriber terminal device 101 shown in FIG. 1 through the communication line 102 to the external data management center 103. In the external data management center 103, the health data are stored in the storage means 302, and the group decision means 303 classifies the subscribers into groups on the basis of the ranges into which the health data of the respective subscribers fall, and then transmits plural advice candidates to each group.

Each subscriber selects at least one advice candidate he/she thinks executable from the plural advice candidates displayed on the display unit 208 of the subscriber terminal device 101, and indicates the selected advice candidate using the operation unit 207, whereby the advice candidate suited to each subscriber is registered in the advice registration means 205 of the external data management center 103. From the next time, the registered advice candidate is transmitted as an advice to the subscriber terminal device 101.

As for a subscriber whose health data, which is periodically transmitted from the subscriber terminal device 101, changes, if the change is outside the range of health data corresponding to the group to which the subscriber belongs at present, the group creation means 515 of the external data management center 103 removes the subscriber from the group to which the subscriber belongs at present, and enters the subscriber into another group, or makes a new group and enters the subscriber into the new group.

In this case, the advising means 508 transmits plural advice candidates from the advice table 509 to the subscriber the group of which has been changed. Thereafter, in the same manner as mentioned above, advices suited to the subscriber are registered in the advice registration unit 513.

As described above, in the health care system according to the first embodiment, the subscribers are classified into groups on the basis of the health data transmitted from the subscribers, and plural advice candidates suited to each group are transmitted to the group. Each subscriber selects at least one advice candidate which is most suitable to him/her from the plural advice candidates, and the selected advice candidate is registered in the external data management center to be transmitted as a practical advice. When there is a change in health data of a subscriber, the group to which the subscriber belongs is changed or newly created, and advice candidates suited to the group are newly transmitted to the subscriber, and the subscriber selects an advice suited to him/her and registers it. Therefore, management of health data is facilitated, and each subscriber is provided with practicable advices at low cost, resulting in a health care system which is useful in improving or maintaining the health condition of each subscriber.

[Embodiment 2]

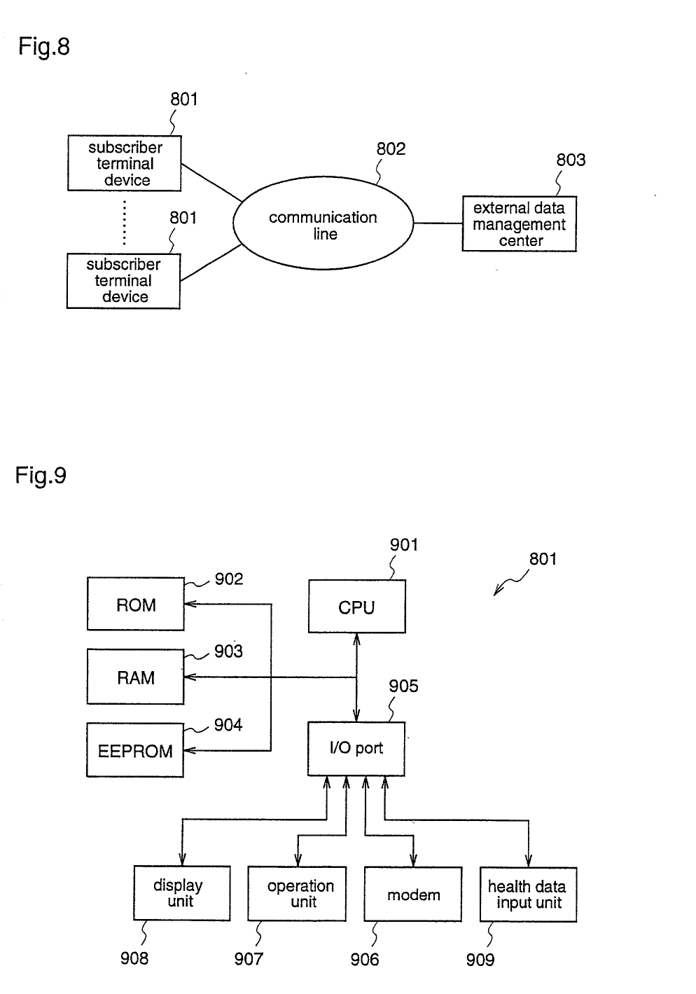

Hereinafter, a second embodiment of the present invention, which is defined in claims 12 26 and claims 31 42, will be described with reference to FIGS. 8 to 20.

In this second embodiment, health improvement is promoted by supporting continuous transmission of health data from subscribers of a health care service, or realizing exchange of information relating to health among the subscribers, or spurring competition on health improvement among the subscribers.

In this second embodiment, it is premised that fasting blood sugar level, weight, and number of steps are employed as health data. Instead of blood sugar level, data relating to blood pressure value or cholesterol value may be employed.

FIG. 8 is a conceptual diagram illustrating a health care system according to the second embodiment.

The health care system according to the second embodiment is provided with an external data management center 803 as a server, and plural subscriber terminal devices 801 which are connectable to the external data management center 803 through a communication line 802.

While in this second embodiment a telephone line is employed as the communication line 802, it is also possible to employ a cable TV, a network such as the Internet, or a radio communication line. Depending on the subscriber, some of these lines may be employed together.

The external data management center 803 may be installed in a data management center of a private company or the like which is independent of a medical institution, or it may be installed in a medical institution.

Each subscriber terminal device 801 may be fixed at a home of the subscriber, or it may be carried by the subscriber. The subscriber terminal device 801 may be integrated with a fixed telephone or a handy phone.

FIG. 9 is a block diagram illustrating an example of the subscriber terminal device 801.

First of all, the subscriber terminal device 801 is provided with, in its minimum scale, a CPU 901, a ROM 902, a RAM 903, an EEPROM 904, an I/O port 905, a modem 906, an operation unit 907, and a display unit 908.

The CPU 901 (first control means) controls the whole of the subscriber terminal device 801.

The ROM 902 stores various kinds of programs or the like.

The RAM 903 (storage means) temporarily holds various kinds of data or the like, which are processed by the CPU 901.

The I/O port 905 (input means) performs input/output of data and control signals to/from the modem 906, the operation unit 907, the display unit 908, and the health data input part 909.

The operation unit 907 (operation means, input means, improvement target setting means) comprises a key board, a ten key pad, switches and the like, with which the subscriber performs various kinds of operations, and input of data or information.

The display unit 908 (display means) comprises an LCD, an LED, or the like, and displays a menu from which the subscriber can select items, health data, information from the external data management center 903, and the like, under control of the CPU 901.

Health data are directly inputted as numeric values from the ten key pad of the operation unit 907, and the inputted health data are stored in the RAM 903. However, there are cases where a health data measuring unit is connected to the health data input unit 909, and transmits data to receive health data, and where a health data measuring unit is contained in the body of the subscriber terminal device 801, and health data are obtained using the measuring unit. Furthermore, health data, which were submitted by mail or facsimile from the subscriber to the external data management center 803 when the subscriber subscribed to the health management service, may be transferred through the communication line 802 to the subscriber terminal device 801. In this case, the subscriber terminal device 801 can dispense with the health data input unit 909.

The modem 906 establishes a communication line with the external data management center 803 according to the operation of the operation unit 207, and performs transmission/reception of data to/from the center 803. The modem 906 may be an arbitrary device which conducts communication between the subscriber terminal device 801 and the external data management center 803 through the communication line 802. For example, a modem for ordinary telephone line, a cable modem for CATV, a modem for XDSL (ADSL, SDSL, or the like), a TA or dial-up rooter for ISDN may be employed.

The EEPROM 904 (storage means) stores the inputted health data, temporal information at measurement, information from the external data management center 803, and the like.

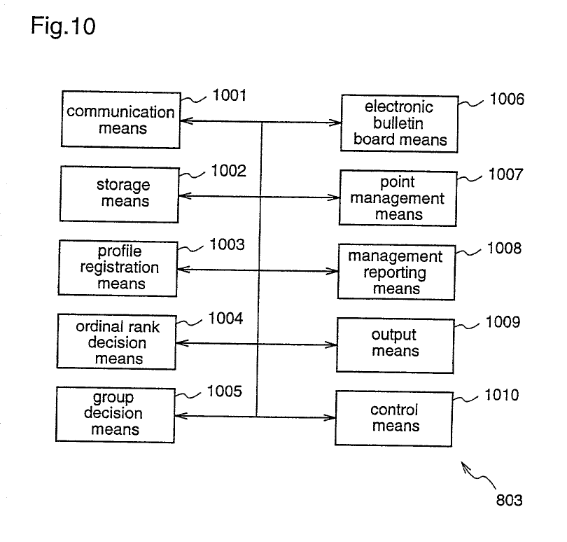

FIG. 10 is a functional block diagram illustrating an example of the external data management center 803. The respective functions are substantially implemented by a server program possessed by the external data management center 803.

As shown in FIG. 10, the external data management center 803 is given various kinds of functions which are substantially implemented by a program.

A communication means 1001 (second communication means) conducts data communication with the subscriber terminal device 801 through the communication line 802, and conducts exchange of information between the respective functions of the external data management center 803 and the subscriber terminal device 801.

A storage means 1002 obtains the health data of the subscriber of the health care service from the subscriber terminal device 801 through the communication means 1001, and stores the health data.

A profile storage means 1003 stores subscriber data including subscriber's initial health data, height data, a target value of health data, individual data such as sex, hobby and the like, and a standard weight calculated from the height, which data are supplied from the subscriber terminal device 801 through the communication means 1001.

According to Japan Fatness Society, the standard weight can be calculated from the height of the subscriber, using an expression: (height m)²×22.

An ordinal rank decision means 1004 calculates the degree of improvement and the degree of accomplishment on the basis of the health data stored in the storage means 1002 and the subscriber data stored in the profile storage means 1003, and decides the ordinal ranks of the subscriber among all subscribers as well as in the group to which the subscriber belongs, with respect to the degree of improvement and the degree of achievement, on the basis of the group to which the subscriber belongs, which group is stored in the group decision means 1005, and holds the improvement rank data and the achievement rank data.

A group decision means 1005 decides the group to which the subscriber belongs, on the basis of the subscriber's sex, hobby, living style (living alone/with family) and the like, which are included in the subscriber data, and holds the decided group to which the subscriber belongs.

An electronic bulletin board means 1006 performs reading of the whole bulletin board data or articles relating to health or the like for each of groups to which the subscribers belong to, or writing of articles, in response to a request transmitted from the subscriber terminal device 801 through the communication means 1001, thereby managing and operating the electronic bulletin board.

A point management means 1007 converts the improvement degree/achievement degree data or the frequency of transmission of health data into service points for requesting a bonus, and accumulates and manages the points earned by the subscriber. Further, the point management means 1007 provides the subscriber terminal device 801 with the accumulated points or bonus information, in response to a request transmitted from the subscriber terminal device 801 through the communication means 1001, and provides the subscriber with a bonus requested by the subscriber, and then exchanges the points for the bonus to manage the remaining points.

This bonus is, for example, presenting the subscriber with a gift such as a product which leads to encouragement of health care or health improvement, or discounting the membership fee to the health care system.

The presentation of gift or the discount of membership fee is carried out by performing electronic commerce between the subscriber and an electronic commerce system which is employed by the manager of the health care system, but it may be manually carried out. Further, it may be consigned to an external institution.

A management reporting means 1008 summarizes, in a table or graph, the health data stored in the storage means 1002 of the external data management center 803 or the improvement degree/achievement degree/ordinal rank data stored in the ordinal rank decision means 1004, and transmits the table or graph through the communication means 1001 to the subscriber terminal device 801, according to a request from the subscriber terminal device 801, or periodically. Alternatively, the management reporting means 1008 outputs the health data or the improvement degree/achievement degree/ordinal rank data to an output means 1009 which is connected to a printer, prints the data, and sends the data to the subscriber or his/her family doctor by means of mail or facsimile.

A control means 1010 (second control means) corresponds to a CPU-of the server, and controls the above-mentioned means 1001 to 1009.

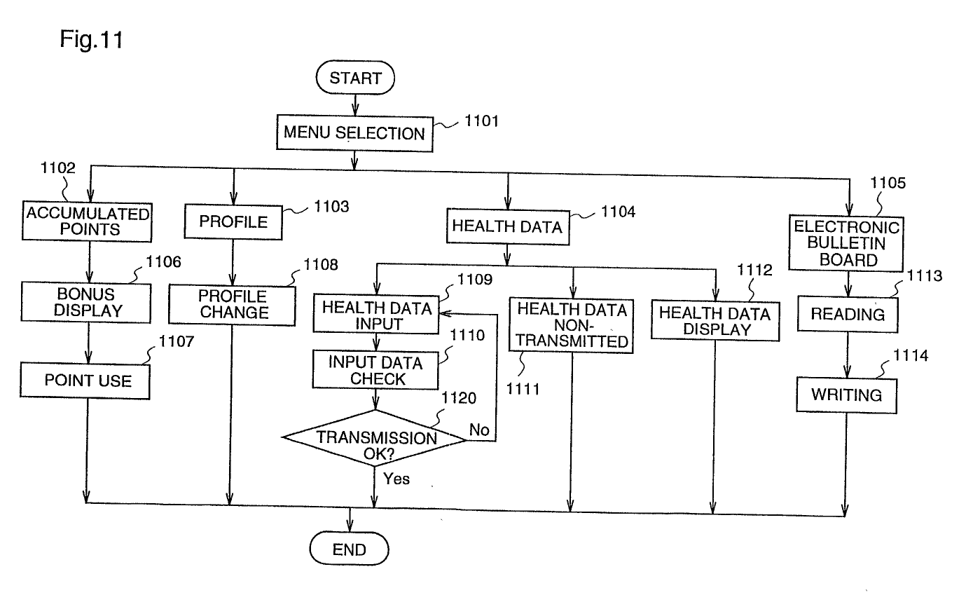

Next, an example of operation of the subscriber terminal device 801 will be described with reference to a flowchart shown in FIG. 11.

The subscriber terminal device 801 selects, by menu selection 1101, one of the following menus: accumulated points 1102, profile 1103, health data 1104, and electronic bulletin board 1105.

When accumulated point 1102 is selected, the accumulated points of the subscriber, which are stored in the point management means 1007, are displayed.

Bonus display menu 1106 displays the contents and kinds of bonuses, such as gifts, as well as the number of points required for point-to-bonus exchange, which are stored in the point management means 1007.

On point use menu 1107, the subscriber selects a bonus he/she desires, and sends the selected bonus information to the point management means 1007.

Profile menu 1103 displays the profile of the subscriber which is stored in the profile registration means 1003, i.e., the subscriber data such as the subscriber's hobby, living alone/ with family, initial health data, target values, and the like.

On profile alteration menu 1008, the subscriber alters the subscriber data, whereby the subscriber data stored in the profile storage means 1003 is altered.

Health data menu 1104 displays the following menu items: health data input 1109, health data non-transmission 1111, and health data display 1112.

When the subscriber selects health data input 1109 from the menu items, the subscriber inputs his/her health data, i.e., blood sugar level, weight, and number of steps, from the ten key pad of the operation unit 907.

On input data confirmation menu 1110, the subscriber checks whether the inputted data can be transmitted or not, and when transmission is OK (1120), the inputted data are transmitted to the external data management center 803 to be stored in the storage means 1002.

When transmission is not OK on input data confirmation menu 1110, the subscriber returns to health data input menu 1109 to re-input the health data.

When the subscriber terminal device 801 is carried by the subscriber and, therefore, it is not connected to the communication line 802, the health data are stored in the EEPROM 904, i.e., the health data are in the transmission-awaiting state.

When health data non-transmission menu 1111 is selected, the subscriber terminal device 801 can transmit the non-transmitted health data stored in the EEPROM 904 to the external data management center 803.

When health data display menu 1112 is selected, the health data or the ordinal rank data, which are summarized in a graph or table by the management reporting means 1008 of the external data management center 803, can be displayed.

On electronic bulletin board menu 1105, menu information is obtained from the electronic bulletin board means 1006 and displayed.

On reading menu 1113, articles are read from the electronic bulletin board means 1006 and displayed.

On writing menu 1114, the subscriber can write follow-up into the articles read from electronic bulletin board means 1006, or the subscriber can write new articles into the electronic bulletin board means 1006.

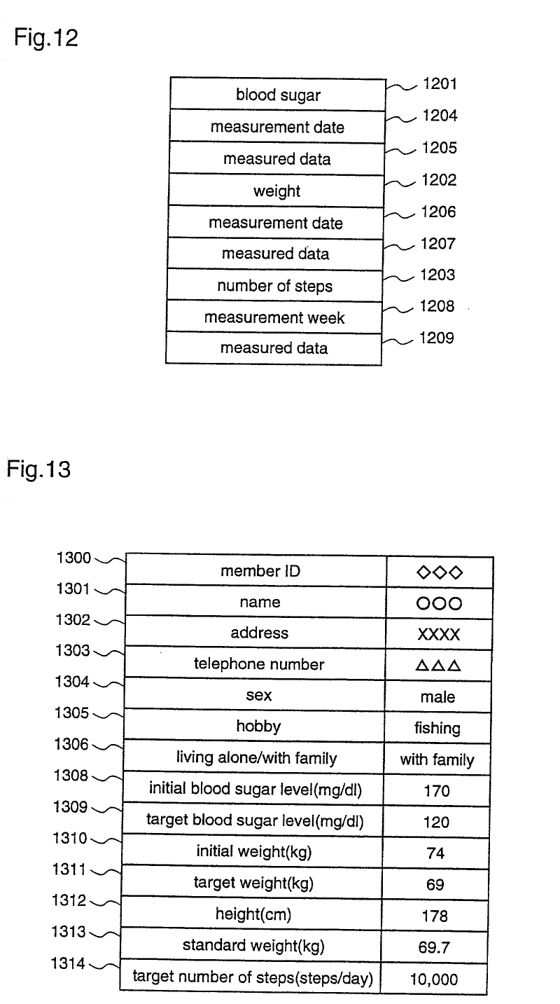

FIG. 12 shows examples of data to be transmitted from the subscriber terminal device 801 to the external data management center 803, more specifically, blood sugar level 1201 and weight 1202 which are measured once a week, measurement dates 1204 and 1206, measured data 1205 and 1207, number-of-steps 1203 over a week, measurement week 1208, and measured data 1209.

FIG. 13 shows an example of subscriber data to be entered into the profile registration means 1003.

The subscriber data includes member ID 1300, name 1301, address 1302, telephone number 1303, sex 1304, hobby 1305, living alone/with family 1306, initial values of health data, i.e., initial blood sugar level 1308 and initial weight 1310, target values of health data, i.e., target blood sugar level 1309, target weight 1311, and target number of steps 1314, standard weight 1313, and height 1312 which is required for measurement of the standard weight.

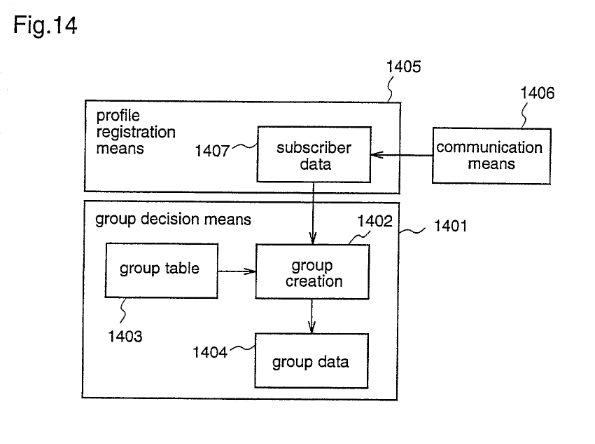

FIG. 14 shows an example of a flowchart for deciding groups to which subscribers belong, and hereinafter, a group deciding procedure will be described.

When subscriber data of subscribers are entered or altered in the subscriber data 1407 of the profile storage means 1405 from the subscriber terminal device 801 through the communication means 1406, the control means (improvement target value registration means) 1010 notifies the group creation unit 1402 of the data entry or alteration in the subscriber data 1407.

On receipt of the notification from the profile storage means 1405, the group creation unit 1402 in the grouping means 1401 decides the group to which the subscriber belongs, on the basis of the subscriber's sex (male or female), hobby (fishing, sports, etc.), and living style (living alone or with family) which are stored in the subscriber data 1407, as well as the group table 1403 indicating the groups to which the subscribers belong according to selection of these items, and then stores the decided group in the group data 1404. This decision of group can be executed by, for example, a method of grouping the subscribers such that the subscribers having common items of subscriber data shown in FIG. 13 are put in the same group.

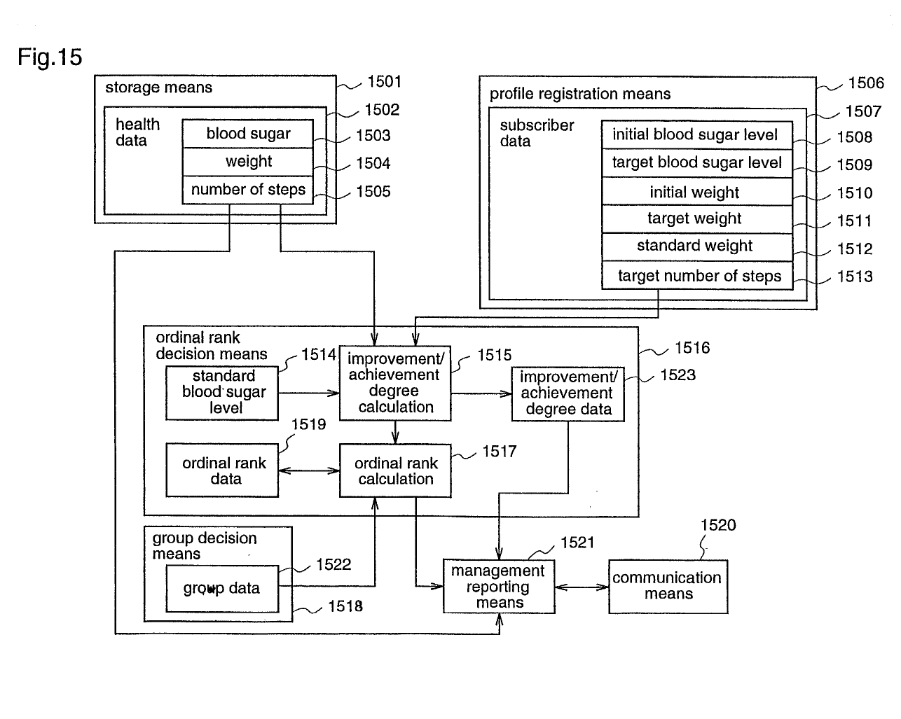

FIG. 15 is a block diagram for explaining calculation of the degree of improvement in health data of each subscriber relative to the standard value, calculation of the degree of achievement relative to the target value, and decision of the ordinal ranks of the improvement degree and the achievement degree. Hereinafter, a description will be given of the degree of improvement, the target value calculating procedure, the degree of achievement, and the procedure for deciding the ordinal rank of the health data of the subscriber.

The improvement degree/achievement degree calculation unit (health data improvement degree calculation means, target value achievement degree calculation means) 1515 calculates the degrees of improvement with respect to the blood sugar level and weight of the subscriber, and the degrees of achievement with respect to the blood sugar level, weight, and number-of-steps, on the basis of the blood sugar level 1503, weight 1504, and number-of-steps 1505 which are the health data 1502 stored in the storage means 1501, as well as the initial blood sugar level 1508, target blood sugar level 1509, initial weight 1510, target weight 1511, standard weight 1512, target number-of-steps 1513, and standard blood sugar level 1514 which are the subscriber data 1507 stored in the profile storage means 1506. The results of the improvement degree/achievement degree calculations are stored in the improvement degree/achievement degree data storage unit 1523.

In the improvement degree/achievement degree calculation unit 1515, the degree of improvement in the blood sugar level is calculated by an expression:

(initial blood sugar level 1508−blood sugar level 1503)/(initial blood sugar level 1508−standard blood sugar level 1514)×100;

the degree of improvement in the weight is calculated by an expression:

(initial weight 1510−weight 1504)/(initial weight 1510−standard weight 1512)×100;

the degree of achievement in the blood sugar level is calculated by an expression:

(initial blood sugar level 1508−blood sugar level 1503)/(initial blood sugar level 1508−target blood sugar level 1509)×100;

the degree of achievement in the weight is calculated by an expression:

(initial weight 1510−weight 1504)/(initial weight 1510−target weight 1511)×100;

and the degree of achievement in the number-of-steps is calculated by an expression:

number-of-steps 1505/target number-of-steps 1513.

Although the standard blood sugar level 1514 may be an arbitrary value, “Diabetes Treatment Guide” (Japan Diabetes Society, 1999) describes the indexes of blood sugar levels. According to this literature, the indexes of blood sugar levels under the blood sugar controlled state are as follows. As for fasting blood sugar levels, “under 100 mg/dl” is excellent, “100 119 mg/dl” is good, and “120 139 mg/dl” is satisfactory. As for blood sugar levels two hours after a meal, “under 120 mg/dl” is excellent, “120 169 mg/dl” is good, and “170 199 mg/dl” is satisfactory. The fasting blood sugar level 100 mg/dl which is excellent is employed as the standard blood sugar level 1514.

The ordinal ranks with respect to the degree of improvement and the degree of achievement are calculated for all of the subscribers by the ordinal rank calculation unit 1517 using the improvement degree/achievement degree data 1523, and furthermore, the ordinary ranks are also calculated for the subscribers in each group on the basis of the subscriber group data 1522. The ordinal ranks thus obtained are stored in ordinal rank data 1519.

Further, the degree of improvement or the degree of achievement can be easily calculated by calculating averages of the blood sugar level 1503, weight 1504, and number-of-steps 1505 in the subscriber health data 1502 over a predetermined period of time and, thereafter, the ordinary ranks may be calculated on the basis of the averages.

When there is a request from the subscriber terminal device 801 through the communication means 1520, the management reporting means 1521 summarizes the health data 1502, improvement degree/achievement degree data 1523, and ordinal rank data 1519 into a table or graph, and transmits the table or graph to the subscriber terminal device 801.

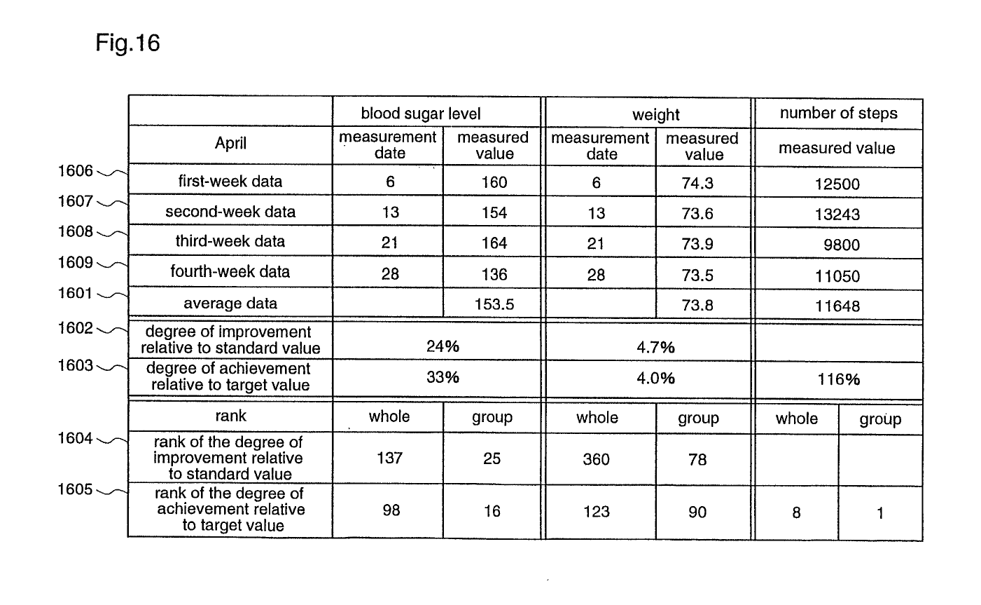

FIG. 16 shows examples of health data 1502, improvement degree/achievement degree data 1523, and ordinal rank data 1519, which are to be transmitted from the management reporting means 1521 to the subscriber terminal device 801.

In FIG. 16, “first week data” 1606, “second week data” 1607, “third week data” 1608, and “fourth week data” 1609 indicate the data of blood sugar level, weight, and number of steps, which are measured by the subscriber once a week; “average data” 1601 indicates the average of each measured data; “improvement relative to standard value” 1602 and “achievement relative to target value” indicate the improvement degree/achievement degree data 1523; and “rank of improvement degree relative to standard value” 1604 and “rank of achievement degree relative to target value” 1605 indicate the ordinal rank data 1519.

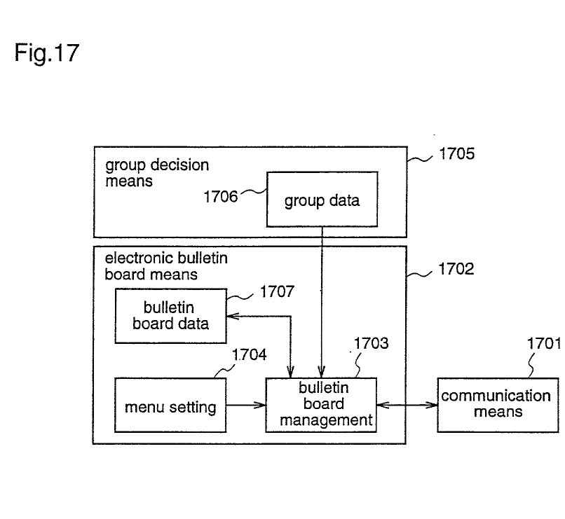

FIG. 17 is a block diagram illustrating an electronic bulletin board means of the external data management center.

When a request to use the electronic bulletin board 1105 is transmitted from the subscriber terminal device 801 through the communication means 1701 to the electronic bulletin board means 1702, the electronic bulletin board management unit 1703 creates a menu into which all of the subscribers can write data, and a group-specified menu which is set by the group data 1706 indicating the group to which the subscriber belongs, on the basis of the setting of the menu setting unit 1704, and transmits these menus to the electronic bulletin board 1105.

When the subscriber terminal device 801 issues a request to read an article, the electronic bulletin board management unit 1703 reads the article from the bulletin board data 1707, and transmits it to the subscriber terminal device 801.

When the subscriber terminal device 801 issues a request to write an article, the electronic bulletin board management unit 1703 writes the article in the electronic bulletin board data 1707.

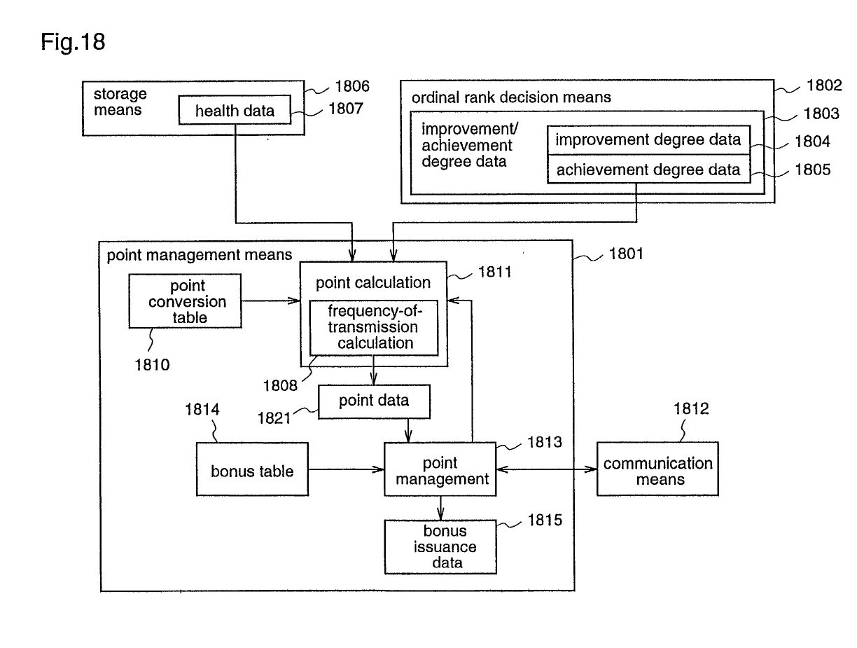

FIG. 18 is a block diagram for explaining a system for encouraging transmission of health data, utilizing points.

In a point management means 1801, a point calculation unit 1811 periodically (e.g., every month) converts improvement degree data and achievement degree data 1805 included in improvement degree/achievement degree data 1803 stored in an ordinal rank decision means 1802, and the frequency of transmission of health data from the subscriber terminal device in a month, which is calculated by a frequency-of-transmission calculation unit 1808 from health data 1807 stored in a storage means 1806, into points with reference to a point conversion table 1810 of a point management means 1801, and stores the points in a point data storage unit 1821.

The point data storage unit 1821 stores a statement of points earned in this month, a total of points in this month, a total of points at the end of the last month, used points in this month, and available points at the end of this month.

When there is a request for accumulated points 1102, which requests information about the points earned by the subscriber, from the subscriber terminal device 801 through the communication means 1812, the point management unit 1813 provides the subscriber terminal device 801 with the data of the points of the subscriber, which data is stored in the point data storage unit 1821.

When there is a request for bonus display 1106 from the subscriber terminal device 801 through the communication means 1812, the point management unit 1813 provides the subscriber terminal device 801 with information of bonus table 1814 which contains bonuses such as gifts, and the number of points required for exchange for each bonus.

When there is a request for point use 1107 from the subscriber terminal device 801 through the communication means 1812, the point management unit 1813 sends the used points corresponding to the bonus selected by the subscriber, to the point calculation unit 1811, and the point calculation unit 1811 subtracts the used points from the accumulated points to calculate the latest accumulated point, thereby updating the point data storage unit 1821. Further, the bonus information used by the subscriber is entered into bonus issuance data 1815, and the bonus is issued to the subscriber according to the data.

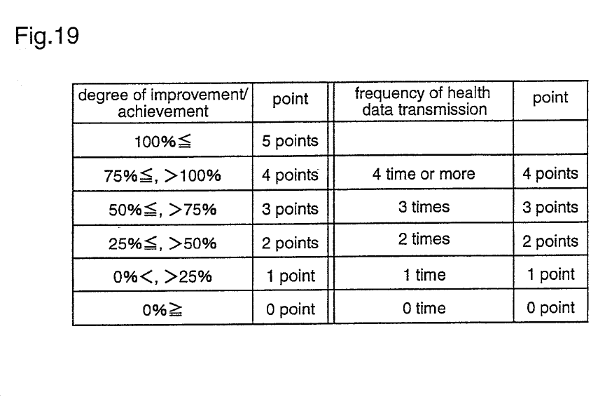

FIG. 19 shows an example of a point conversion table 1810 to be used for conversion of the improvement degree data and achievement degree data which are stored in the improvement degree/achievement degree data 1803, and the frequency of transmission of health data, into points.

In the example of FIG. 19, five points are added to the accumulated points when the degree of improvement or the degree of achievement is equal to or higher than 100%, and four points are added when the frequency of transmission of health data is equal to or larger than four times in a month.

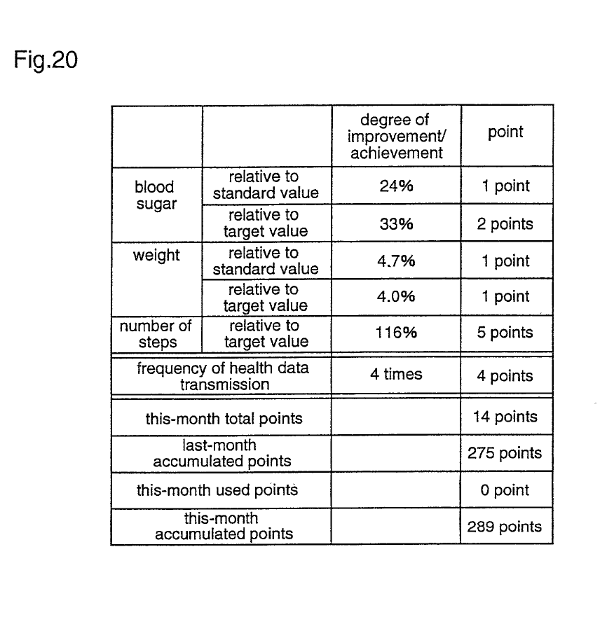

FIG. 20 shows an example of data of accumulated points to be transmitted to the subscriber terminal device 801.

In the example of FIG. 20, as well as the numeric values indicating the degrees of improvement or achievement in the blood sugar level, weight, and number of steps, the earned points corresponding thereto are displayed, and further, a total of points earned in this month, accumulated points in the last month, used points in this month, and accumulated point at the end of this month are displayed.

Hereinafter, a description will be given of the operation of the whole health care system according to the second embodiment. The subscribers sends their profile data from the subscriber terminal devices 801 through the communication line to the external data management center 803. In the external data management center 803, the transmitted profile data are stored in the profile storage means 1003, and the group decision means 1005 groups the subscribers on the basis of the stored profile data. This grouping is carried out such that the subscribers having common items of profile data are put in the same group.

Further, each of the subscribers sends his/her health data and the target value of improvement in the health data, from the subscriber terminal device 801 through the communication line 802 to the external data management center 803. In the external data management center 803, the degree of improvement in the transmitted health data, the degree of achievement to the target value, and the frequency of transmission of health data, are calculated with reference to the stored target value, and issues service points on the basis of the result of the calculation. Accumulation of the service points becomes one of motivations of the subscriber to have an aspiration for health improvement.

Further, topics on health or stories of experiences are shown on the electronic bulletin board, and the subscribers can obtain information to refer to, whereby health improvement is encouraged more strongly than in the case where each subscriber tackles with health improvement by him/herself.

Furthermore, since the data of the subscribers in the same group are displayed on the electronic bulletin board, the posture or aspiration of each subscriber for health improvement is further enhanced by, for example, competing with another subscriber in the number of points.

As described above, according to the health care system of this second embodiment, the health data transmitted from the subscriber is converted into service points with reference to the degree of improvement, degree of achievement, and the frequency of transmission, and a bonus is issued on the basis of the points, information on health improvement from another subscriber is displayed on the electronic bulletin board, or the subscribers compete each other in the number of points, whereby health improvement is encouraged. Therefore, it is possible to realize a health care system which contributes to health improvement with far less labor than in the case where each subscriber tackles with health improvement by him/herself.

[Modification of Embodiment 2]

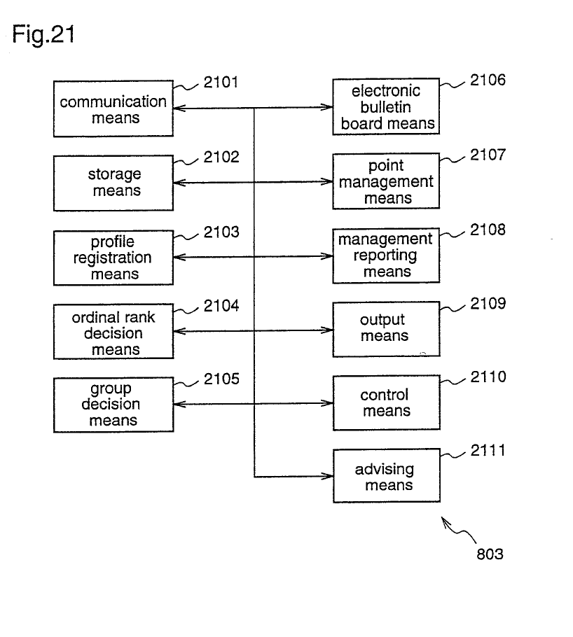

As shown in FIG. 21, an advising means 2111 may be added to the construction corresponding to the external data management center according to the second embodiment shown in FIG. 8, thereby automatically creating advices suited to each subscriber.

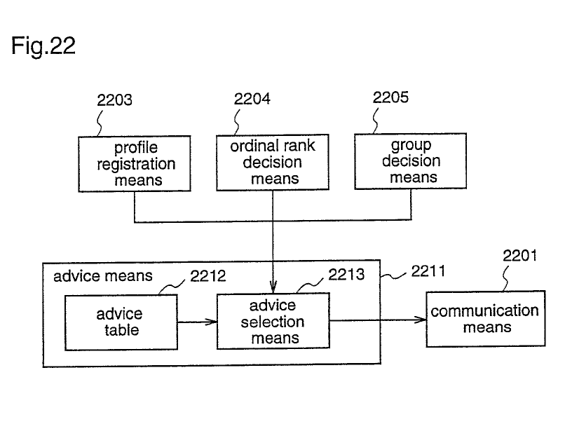

FIG. 22 shows the construction of the advising means in this case. With reference to FIG. 22, an advice selection means 2213 selects an advice candidate which is considered most suitable for the subscriber, from an advice table 2212, after checking the life style and health condition of the subscriber and the situation of the group to which the subscriber belong, with reference to the contents stored in a profile registration means 2203 (corresponding to 2103 in FIG. 21), and the contents stored in a rank decision means 2204 (2104 in FIG. 21) and a group decision means 2205 (2105 in FIG. 21) and, thereafter, transmits the selected advice candidate, as an advice, to the communication means 2201. This selection may be carried out on the basis of an inference rule or a neural technology.

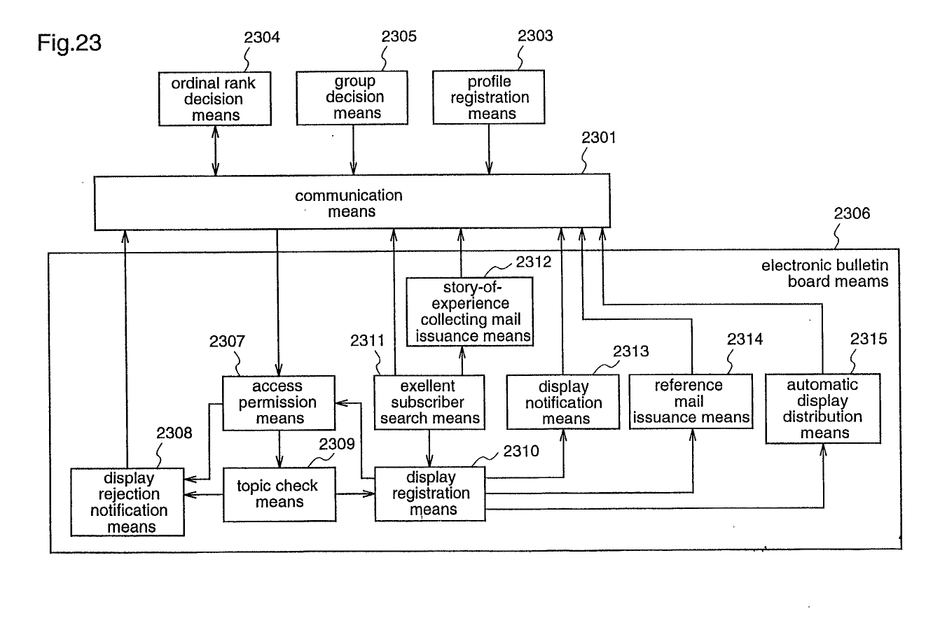

On the other hand, an electronic bulletin board means 2306 may be provided with various kinds of functions as shown in FIG. 23.

That is, an access permission means 2307 decides whether an access is from an authorized subscriber or not, according to pass words or the like.

Next, even when the access is from an authorized subscriber, a topic checking means 2309 checks the contents as to whether it relates to health or not. This check can be carried out by referring to dictionary data in which words relating to health are entered.

When the topic is other than health, a display rejection notification means 2308 may give a warning by E-mail to the subscriber who has sent the contribution.

Further, a contribution which has passed the check by the topic checking means 2309 is displayed on the bulletin board by a display registration means 2310. An excellent subscriber searching means 2311 searches the ordinal ranks decided by the rank decision means 2304 for an excellent subscriber with respect to the degree of improvement or the degree of target achievement, and a story-of-experience collecting mail issuance means 2312 issues an E-mail which encourages the excellent subscriber to contribute a story of his/her experience.

Further, when a new contribution is displayed on the electronic bulletin board, a display notification means 2313 may send E-mail which informs all subscribers of the new contribution, or the group decision means 2305 may send the displayed contents as reference mail to the subscribers who belong to the group for which the displayed contents will be helpful. When the state where no subscriber views the electronic bulletin board continues over a predetermined period of time, an automatic distribution means 2315 may distribute the contents displayed on the bulletin board to the subscribers by E-mail.

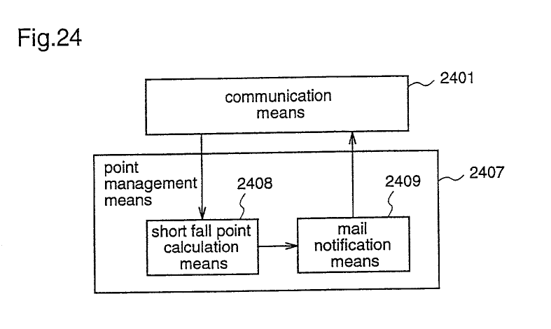

Furthermore, as shown in FIG. 24, the point management means 1407 may be provided with a point shortfall calculation means 2408 and a mail notification means 2409. In this case, the point shortfall calculation means 2408 calculates a shortfall in accumulated points required for exchanging the points for a bonus such as a gift, and the mail notification means 2401 notifies the corresponding subscriber of the shortfall in accumulated points through the communication means 2401.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A health care system for exchanging data of predetermined subscribers between plural subscriber terminal devices and a data management center through a communication line, wherein
each of the subscriber terminal devices comprises:
an input means for inputting health data of the corresponding subscriber;
a storage means for holding the health data inputted by the input means;
a first communication means for performing data communication with the data management center;
a display means for displaying the health data inputted by the input means, and information transmitted from the data management center; and
an operation means with which the subscriber performs a series of operations; and
the data management center comprises:
a second communication means for performing data communication with each of the respective subscriber terminal devices;
a storage means for holding health data transmitted from each of the subscriber terminal devices;
a group decision means for deciding a group to which each subscriber belongs, on the basis of plural pieces of health data obtained from the storage means; and
an advising means for providing each subscriber terminal device with plural advice candidates which are common to subscribers in the group to which the subscriber terminal device belongs, through the second communication means.

2. A health care system as defined in claim 1, wherein the subscriber terminal device further includes an advice selection means for selecting at least one advice candidate which is desired by the corresponding subscriber, from the plural advice candidates supplied from the advising means.

3. A health care system as defined in claim 2, wherein
the data management center further includes an advice registration means for holding the advice candidate selected by the advice selection means; and
the data management center provides the subscriber terminal device with the advice candidate stored in the advice registration means, as an advice, by the advising means.

4. A health care system as defined in claim 1, wherein
the group decision means remakes the group to which the subscriber belongs, according to a change in the health data transmitted from the subscriber terminal device; and
the advising means provides the subscriber terminal device with plural advice candidates which are common to the subscribers who belong to the remade group.

5. A health care system as defined in claim 1, wherein the health data includes data relating to blood sugar level, and weight or body mass index (BMI).

6. A health care system as defined in claim 1, wherein the health data includes data relating to blood pressure, and weight or body mass index (BMI).

7. A health care system as defined in claim 1, wherein the health data includes data relating to cholesterol, and weight or body mass index (BMI).

8. A health care system as defined in claim 1, wherein the health data includes data relating to neutral fat, and weight or body mass index (BMI).

9. A health care system as defined in claim 1, wherein the health data includes data relating to glutamic acid oxaloacetic acid transaminase (GOT), and weight or body mass index (BMI).

10. A health care system as defined in claim 1, wherein the health data includes data relating to glutamic acid pyrivic acid transaminase (GPT), and weight or body mass index (BMI).

11. A health care system as defined in claim 1, wherein the health data includes data relating to γ-glutamyl transpeptidase (γ-GTP), and weight or body mass index (BMI).

12. A health care system for exchanging data of predetermined subscribers between plural subscriber terminal devices and a data management center through a communication line, wherein
each of the subscriber terminal devices comprises:
an input means for inputting health data;
a storage means for holding the health data inputted by the input means;
a first communication means for performing data communication with the data management center;
a display means for displaying the health data and information from the data management center; and
an operation means with which the subscriber performs a series of operations; and
the data management center comprises:
a second communication means for performing data communication with the subscriber terminal devices; and
an ordinal rank decision means for deciding the ordinal ranks of the health data among the plural subscribers, on the basis of the health data which are obtained from the storage means for holding the health data transmitted from the subscriber terminal devices.

13. A health care system as defined in claim 12, wherein
the ordinal rank decision means includes a health data improvement degree calculation means for calculating the degree of improvement in the health data of each subscriber by comparing the health data with a standard value or an index value; and
the ordinal rank according to the degree of improvement is employed as the ordinal rank of the health data.

14. A health care system as defined in claim 12, wherein the subscriber terminal device further includes an improvement target setting means for setting an improvement target value of the health data.

15. A health care system as defined in claim 12, wherein
the data management center further includes an improvement target value registration means for holding the improvement target value which is set by the improvement target setting means of claim 14, through the second communication means;
the ordinal rank decision means includes a target value achievement degree calculation means for calculating the degree of achievement to the improvement target value of the subscriber, which is stored in the improvement target value registration means; and
the ordinal rank according to the degree of achievement is employed as the ordinal rank of the health data.

16. A health care system for exchanging data of predetermined subscribers between plural subscriber terminal devices and a data management center through a communication line, wherein
each of the subscriber terminal devices comprises:
an input means for inputting health data and information;
a storage means for holding the health data and information which are inputted by the input means;
a first communication means for performing data communication with the data management center;
a display means for displaying the health data and information from the data management center; and
an operation means with which the subscriber performs a series of operations; and
the data management center comprises:
a second communication means for performing data communication with the subscriber terminal devices;
a storage means for holding the health data transmitted from the subscriber terminal devices; and
an electronic bulletin board means in/from which topics or the like relating to health can be written or read by the subscriber terminal devices through the second communication line.

17. A health care system for exchanging data of predetermined subscribers between plural subscriber terminal devices and a data management center through a communication line, wherein
each of the subscriber terminal devices comprises:
an input means for inputting health data and information;
a storage means for holding the health data and information which are inputted by the input means;
a first communication means for performing data communication with the data management center;
a display means for displaying the health data and information from the data management center; and
an operation means with which the subscriber performs a series of operations; and
the data management center comprises:
a second communication means for performing data communication with the subscriber terminal devices;
a storage means for holding the health data transmitted from the subscriber terminal devices;
a profile registration means for holding profile data of each subscriber, such as sex, hobby and the like; and
a group decision means for deciding a group to which each subscriber belongs, on the basis of the stored profile data of the subscriber.

18. A health care system as defined in claim 17, wherein the data management center further includes an ordinal rank decision means for deciding the ordinal ranks of the health data among the subscribers in the group to which the subscribers belong, which group is created by the group decision means on the basis of the health data obtained from the storage means.

19. A health care system as defined in claim 18, wherein
the ordinal rank decision means includes a health data improvement degree calculation means for calculating the degree of improvement in the health data of each subscriber by comparing the health data with a standard value or an index value; and
the ordinal rank based on the degree of improvement is employed as the ordinal rank of the health data.

20. A health care system as defined in claim 17, wherein the subscriber terminal device includes an improvement target setting means for setting an improvement target value of the health data.

21. A health care system as defined in claim 17, wherein
the data management center includes an improvement target value registration means for holding the improvement target value which is set by the improvement target setting means of claim 20, through the second communication means;
the health data ordinal rank decision means of claim 18 includes a target value achievement degree calculation means for calculating the degree of achievement to the improvement target value of each subscriber, which target value is stored in the improvement target value registration means that decides the ordinal ranks of the health data among the subscribers in the group to which the subscribers belong; and
the ordinal rank according to the degree of achievement is employed as the ordinal rank of the health data of each subscriber.

22. A health care system as defined in claim 17, wherein the data management center includes an electronic bulletin board means in/from which topics or the like relating to health can be written or read by the subscriber terminal devices through the second communication means, only in the group to which the subscribers belong, which group is created by the group decision means.

23. A health care system as defined in claim 12 or 17 further including a point management means for
converting at least one of the degree of improvement described in claim 13, the degree of achievement described in claim 15, and the number of transmission of the health data which are obtained from the storage means for holding the health data transmitted from the subscriber terminal device, into service points (hereinafter, referred to simply as points),
accumulating and managing the points, and sending the accumulated points and bonus information such as gifts to the subscriber terminal device through the second communication means, when there is a request to use the points from the subscriber terminal device through the second communication means, and
when there is a request for a bonus such as a gift from the subscriber terminal device, exchanging the points corresponding to the bonus, for the bonus.

24. A health care system as defined in any of claims 12, 16, 17, and 23, wherein the health data includes data relating to blood sugar level, weight, and number of steps.

25. A health care system as defined in any of claims 12, 16, 17, and 23, wherein the health data includes data relating to blood pressure, weight, and number of steps.

26. A health care system as defined in any of claims 12, 16, 17, and 23, wherein the health data includes data relating to cholesterol, weight, and number of steps.

27. A health care system as defined in claim 1, wherein
the subscriber terminal device further includes a first control means for controlling the respective means constituting the subscriber terminal device;
the data management enter further includes a second control means for controlling the respective means constituting the data management center;
the first control means controls the first communication means so as to transmit the health data of the subscriber, which is inputted from the input means;
the second control means controls the second communication means so as to receive the health data;
the second control means controls the group decision means so as to decide a group to which the subscriber belongs, on the basis of the health data; and
the second control means controls the advising means so as to create advice candidates suited to the group.

28. A health care system as defined in claim 27, wherein
the first control means controls the first communication means so as to receive the advice candidates;
the first control means controls the display means of claim 1 so as to display the advice candidates; and
the first control means controls the first communication means so as to transmit an advice candidate selected by the input means of claim 1.

29. A health care system as defined in claim 27, wherein
the second control means controls the second communication means so as to receive the selected advice candidate described in claim 28;
the second control means controls the storage means of claim 1 so as to hold at least one advice candidate received; and
the second control means controls the second communication means so as to transmit the stored advice.

30. A health care system as defined in claim 27, wherein
the second control means controls the group decision means so as to remake the group according to a change in the health data transmitted through the first communication means; and
the second control means controls the second communication means so as to transmit plural advice candidates which are common to the remade group.

31. A health care system as defined in claim 12, wherein
the subscriber terminal device further includes a first control means for controlling the respective means constituting the subscriber terminal device;
the data management center further includes a second control means for controlling the respective means constituting the data management center;
the first control means controls the first communication means so as to transmit the health data;
the second control means controls the second communication means so as to receive the health data; and
the second control means controls the ordinal rank decision means so as to decide the ordinal ranks among the subscribers on the basis of the health data.

32. A health care system as defined in claim 31, wherein the second control means controls the ordinal rank decision means so as to calculate the degree of improvement in the health data of each subscriber by comparing the health data with a standard value or an index value, as the ordinal rank of the heath data.

33. A health care system as defined in claim 31, wherein the first control means controls the first communication means so as to transmit the improvement target value of the health data which is inputted by the input means of claim 12, thereby setting the improvement target value.

34. A health care system as defined in claim 31, wherein
the second control means controls the second communication means so as to receive the improvement target value described in claim 33, and controls the storage means of claim 12 so as to hold the improvement target value;
the second control means controls the ordinal rank decision means so as to calculate the degree of achievement on the basis of the health data received from the second communication means and the stored improvement target value; and
the second control means controls the ordinal rank decision means so as to decide the ordinal rank of the health data according to the rank based on the degree of achievement.

35. A health care system as defined in claim 16, wherein
the subscriber terminal device further includes a first control means for controlling the respective means constituting the subscriber terminal device;
the data management center further includes a second control means for controlling the respective means constituting the data management center;
the first control means controls the first communication means so as to transmit topics relating to health or the like;
the second control means controls the second communication means so as to receive the topics relating to health or the like; and
the second control means control the electronic bulletin board means so as to display the received topics.

36. A health care system as defined in claim 17, wherein
the subscriber terminal device further includes a first control means for controlling the respective means constituting the subscriber terminal device;
the data management center further includes a second control means for controlling the respective means constituting the data management center;
the first control means controls the first communication means so as to transmit profile data of the subscriber;
the second control means controls the second communication means so as to receive the profile data, and controls the storage means so as to hold the profile data; and
the second control means controls the group decision means so as to decide the group to which the subscriber belongs, on the basis of the profile data stored in the storage means.

37. A health care system as defined in claim 36, wherein the second control means controls the ordinal rank decision means of claim 31 so as to decide the ordinal rank of the health data within the group to which the subscriber belongs, which group is decided by the group decision means.

38. A health care system as defined in claim 37, wherein
the second control means controls the second communication means of claim 36 so as to receive the health data of the subscriber; and
the second control means controls the ordinal rank decision means of claim 17 so as to calculate the degree of achievement by comparing the received health data with a standard value or an index value.

39. A health care system as defined in claim 36, wherein the first control means controls the first communication means so as to transmit the improvement target value of the health data which is inputted by the input means of claim 17.

40. A health care system as defined in claim 36, wherein
the second control means controls the second communication means so as to receive the improvement target value described in claim 33;
the second control means controls the storage means so as to hold the received improvement target value; and
the second control means control the ordinal rank decision means of claim 31 so as to calculate the degree of achievement to the improvement target value of the subscriber.

41. A health care system as defined in claim 36, wherein the second control means controls the electronic bulletin board means of claim 22 so as to permit only the subscribers decided by the group decision means to read or write data from/in the bulletin board means.

42. A health care system as defined in claim 31 or 36, wherein
the second control means controls the point management means of claim 23 so as to convert at least one of the degree of improvement calculated by the health data improvement degree calculation means of claim 13, the degree of target achievement calculated by the target achievement degree calculation means of claim 15, and the number of transmission of the health data obtained from the storage means, into service points (hereinafter referred to simply as points);
the first control means controls the first communication means so as to transmit a request to use the points, which request is inputted from the input means of claim 17;
the second control means controls the second communication means so as to transmit information about bonuses which can be obtained using the points;
the first control means controls the first communication means so as to receive the bonus information;
the first control means controls the first communication means so as to transmit the bonus information selected by the input means; and
the second control means controls the point management means so as to exchange the points for the bonus corresponding to the selected bonus information.
